(19) United States
(12) Patent Application Publication
(10) Pub. No.: US 2011/0061011 A1
(43) Pub. Date: Mar. 10, 2011

(54) Three-Dimensional Shopping Lists

(76) Inventor: Ramsay Hoguet, Marblehead, MA (US)

(21) Appl. No.: 12/555,655

(22) Filed: Sep. 8, 2009

Related U.S. Application Data
(60) Provisional application No. 61/240,108, filed on Sep. 4, 2009.

(51) Int. Cl. G06F 3/048

(52) U.S. Cl. 715/769; 715/853

(57) ABSTRACT

A method performed using a processing device includes rendering, on a display associated with the processing device, a diagram of a plan for a layout. The diagram includes one or more element locations. An indication is received, via the processing device, of a selection of a first element from a list of elements associated with the diagram. The first element is added to a list of elements. An association is identified, via the processing device, between the first element and one or more of the element locations. The diagram is updated to include a graphical representation of the first element within the diagram at one or more of the element locations.

### CROSS REFERENCE TO RELATED APPLICATIONS

Pursuant to 35 USC §119(e), this application claims the benefit of prior U.S. Provisional Application Ser. No. 61/240,108, filed Sep. 4, 2009, which is incorporated herein by reference in its entirety. U.S. application Ser. No. 12/270,470, filed Nov. 13, 2008 is also incorporated by reference in its entirety.

### TECHNICAL FIELD

This patent application relates generally to three-dimensional (3D) shopping lists.

### BACKGROUND

Designing the layout and products to include in a room can be a time consuming process. For example, a person designing a room can select various products to include in the room by collecting pages from magazines or from the internet. The typical homeowner will spend months planning a home improvement project. The result can be an unorganized collection of pages torn out of magazines and catalogs, stacks of books with bookmarked pages, lengthy bookmark lists with poor naming conventions, and sketches of designs that are not to scale.

### SUMMARY

In general, in some aspects, a method performed using a processing device includes rendering, on a display associated with the processing device, a diagram of a plan for a layout. The diagram includes one or more element locations. An indication is received, via the processing device, of a selection of a first element from a list of elements associated with the diagram. The first element is added to a list of elements. An association is identified, via the processing device, between the first element and one or more of the element locations. The diagram is updated to include a graphical representation of the first element within the diagram at one or more of the element locations.

Implementations can include one or more of the following features. The first element is selected from the source of elements. The list of elements includes one or more alternative elements. One or more of the plan, the list of elements, and the source of elements is generated based on one or more attributes of an image. The one or more attributes comprise one or more of a texture of the image, a color of the image, a pattern of the image, or tags associated with the image. The diagram is imported from a computer aided drawing (CAD) file. One or more of the plan, the source of elements, and the list of elements is generated based on keywords. A second element is added to the list of elements by receiving one or more commands to drag a graphical representation of the second element onto a graphical representation of the list of products, or by receiving one or more commands to activate a button associated with the second element. The second element is added to the list of elements with a designation of an alternative element, a new element, or an active element. If the second element is designated as an alternative element, the diagram is not updated with a graphical representation of the second element. An association is attempted to be identified between the second element and one or more of the element locations if the second element is designated as a new element. If no association is determined, a user is prompted to manually associate the second element with one or more of the element locations. If the second element is designated as an active element, the diagram is updated with a graphical representation of the second element. If the second element is designated as an alternative element, the designation of the second element is changed from an alternative element to an active element causes the diagram to be updated with a graphical representation of the second element. The list of elements and designations of the elements are stored as a first snapshot. A second list of elements and designations of the elements are stored as a second snapshot, and toggling between the first snapshot and the second snapshot displays the list of elements and designations of the elements stored within respective snapshots. Toggling between the first snapshot and the second snapshot updates the diagram based on designations of the elements. An association is attempted to be identified between the first element and one or more of the element locations if the diagram is altered. If no association is determined, a user is prompted to manually associate the first element with one or more of the element locations. Element locations are graphically represented within the diagram by generic elements. The association is identified based on a design rules engine that identifies associations based on contextual relationships. The updating comprises rendering a graphical representation of one or more cabinets in the diagram according to a design rules engine. The design rules engine determines one of more of the type, position, or size of the cabinets based at least in part on zones defined by the layout. The first element comprises a product, and the layout comprises a room layout. The zones are prioritized according to user-provided attributes. The user-provided attributes comprise answers to a questionnaire. The design rules engine compares the cabinet arrangement to one or more pre-defined cabinet arrangements. The cabinet arrangement is manually modified by a user.

### DESCRIPTION OF THE DRAWINGS

FIGS. 1-7B are diagrams of a home design tool.

FIGS. 8-11 are diagrams an interface for generating a 3D shopping list.

FIG. 12 is a flow chart of a process for generating a 3D shopping list.

FIGS. 13-15 are diagrams of a home design tool.

FIGS. 16A and 16B are flow charts.

FIGS. 17-19 are screenshots.

FIGS. 20 and 21 are flow charts of processes for manipulating CAD data.

FIG. 22 is a screenshot.

FIG. 23 is a flow chart of a process for presenting alternative layouts.

FIG. 24 is a block diagram of a computing system.

### DETAILED DESCRIPTION

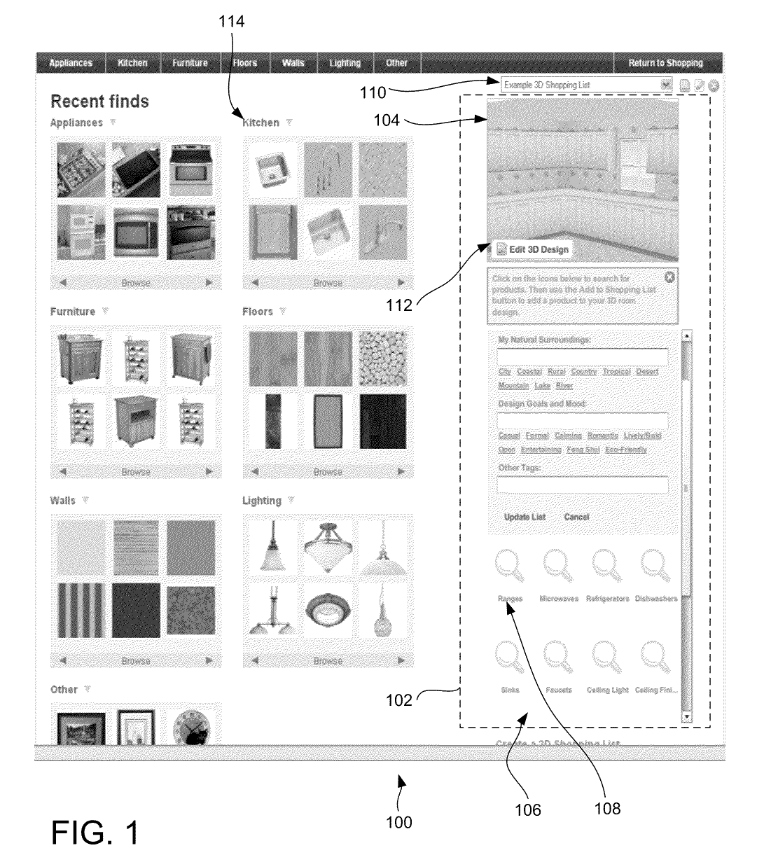

FIG. 1 shows a home, landscape, and clothing design tool 100 (referred to herein as the “home design tool”) implemented within a web page. The home design tool is a computer software based tool that enables a user to collect information about home design products from websites on a network (e.g., the Internet) and use the collected information to design one or more rooms.

In the example of FIG. 1, the home design tool 100 includes a three dimensional shopping list (“3D shopping list”) 102. Shopping list 102 is referred to as a “3D” shopping list because a user is able to browse or shop for products while simultaneously designing one or more rooms. The 3D shopping list is a combination of a design template 104 and a product list 106. The design template 104 includes a three-dimensional view of a room based on a layout, although two dimensional (“2D”) design templates can also be used. The design template 104 allows a user to view the home design products and the placement of those products within the room, as well as the overall layout of the room. The home design tool 100 may include 2D and 3D representations for objects within the room. In 3D, the system displays the 3D representation of objects using a standard graphics pipeline with parallel projection. Some implementations may use hardware acceleration to provide more realistic and more detailed geometry model rendering.

In some examples, objects in the design template 104 have corresponding objects 108 in the product list 106. If there is no product in the product list, then the object type is represented by a search icon (e.g., the magnifying glass depicted for the object type “Ranges” in FIG. 1). In the example of FIG. 1, the design template 104 contains no products and, as a result, the product list 106 contains only search icons. The product list can also include search icons for products that are not called for in the design template 104. Products can be added to the product list 104 using a plurality of techniques. For example, a user can use a mouse cursor to “drag and drop” products from a product source 114 (e.g., a list of products that can be browsed, purchased, added to a room design, or added to the product list 106) to the product list 106, which would cause the search icon (magnifying glass) to be replaced with a graphical representation of the added product. The product list 106 can contain multiple instances of the same object type. For example, the object type “Ranges” could instead appear as “Range 1” and “Range 2,” allowing for room designs containing two or more ranges. The “edit 3D design” button allows a user to enter a mode in which the layout of the room can be altered or replaced.

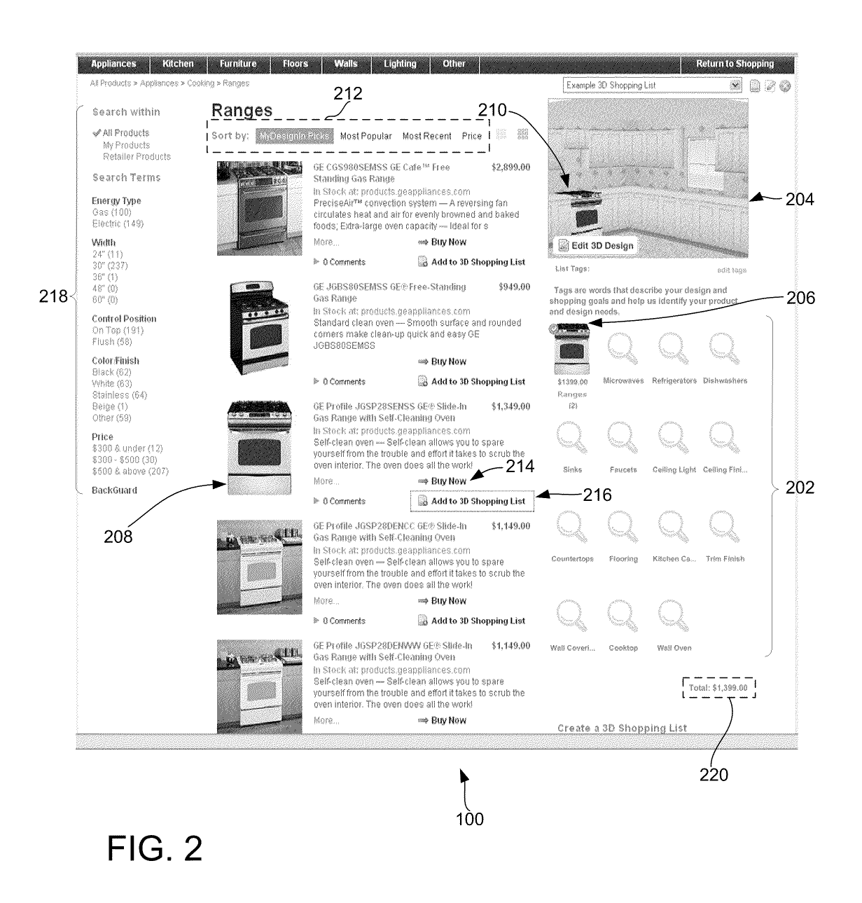

Referring to FIG. 2, home design tool 100 is shown that includes a product list 202 and a design template 204. In the example of FIG. 2, a category of “Ranges” has been selected within the product source 114 (FIG. 1), and products within the Ranges category are displayed within the product source, such as range 208. The product source 114 can be filtered, searched, and browsed using filters 212 (e.g., most popular, most recent, price, etc . . . ), and can also be filtered by characteristics of the products within a particular category of products. For example, the products within the Ranges category can be filtered according to a set of filter options 218, which includes characteristics of the products within the Ranges category (e.g., a width of the product, an energy type of the product, etc . . . ). A user can use filters, searches, and/or other techniques (described in greater detail below) to locate products within the product source 114, and to add products to the product list 202.

The product source 114 can be organized into categories based on the product categorization and into subcategories based on the type of the product. Exemplary product categories include appliances; kitchen cabinets; plumbing fixtures; flooring; appliances; building structure; cabinets and storage; floors; walls; counters; furniture; accessories; landscaping/outdoor; lighting; plumbing; and others. Each of these product categories can be sub-divided into particular types of products. An exemplary subdivision of product categories into particular types of products is shown to follow:

Appliances
Cooktops
Dishwashers
Laundry
Microwave Ovens
Ovens
Ranges
Refrigerators
Other

Building Structure
Columns
Doors
Fireplaces
Railings
Stairs
Windows
Wood Stoves
Other

Cabinets & Storage
Closets
Kitchen Cabinet
Bathroom Cabinet
Pantry
Wine Storage

Floors, Walls & Countertops
Architectural Elements
Carpeting
Ceilings
Countertops
Floor Laminate
Hardwood Flooring
Paint
Rugs
Tile
Vinyl
Wallpaper
Window Coverings
Other

Furniture & Accessories
Bedding & Linens
Beds
Chairs
Decorative Accessories
Decorative Hardware
Desks
Fabrics
Kitchen Accessories
Ottomans
Plants—Indoor
Sofas
Tables
Tableware
Other

Lighting
Lamps
Ceiling—Attached
Wall—Attached

Landscape & Outdoors
Arbors
Columns
Fences
Hot Tubs
Outdoor Furniture
Patio Stones
Plants
Pools
Spas
Trees
Wall Stones
Other

Plumbing
Bath/Showers
Bathtubs
Faucets
Hot Tubs & Spas
Sinks—Bathroom
Sinks—Kitchen
Saunas & Steam Baths
Showers
Toilets
Other

Other
Heating & Cooling
Art

For example, the category of plumbing fixtures can include products types such as faucets, sinks, and tubs. Arranging the products into product categories and product types can provide various advantages such as making the information more easily accessible for the user to search for these products or to browse a product directory based on these types of categories.

In the example of FIG. 2, range 208 has been added to product list 202. Because the product list now contains a product for the object type “Ranges,” the search icon has been replaced with a product icon 206 that corresponds to the range 208. In some examples, a user adds a product to the product list by activating an “add button” 216 associated with the desired product (e.g., add button 216 corresponds to range 208). Using an input device, such as a mouse, keyboard, or trackball, a user can manipulate a cursor on a display to activate the add button 216, which causes the range 208 to be added to the product list 202 and the design template 204 simultaneously. In effect, one-click design can be achieved by activating the add button 216, as the user is allowed to add a product to both the product list 202 and the design template 204 with only one click. Home design tool 100 can determine where to place a product within product list 202 or design template 204 by identifying associations between a product on the product list 202 and a product location within the design template 204.

As described above, the range 208 could also be added to the product list 202 by, for example, dragging and dropping the range 208 onto the product list 202. The range 208 could also be added to the design template 204 directly (e.g., by one of the user actions described above), which can cause the product list 202 to be updated with the added product. If a user wants to purchase a product, a user can activate a “purchase button” 214 associated with the desired product (e.g., range 208). A product price total 220 is also included in the product list in order to show the total purchase price for the products within the product list. The total price can be configured to include active products, alternative products, or both (the qualities of which will be further described below).

Upon adding the range to the product list 202 or the design template 204, a 3D product model 210 can be generated within the design template 204. In the example of FIG. 2, a user has added range 208 to the product list 202. As a result, the range 208 is represented in the design template 204 by the 3D product model 210, which may or may not bear a visual resemblance to the range 208.

The home design tool 100 generates 3D product models 210 within the design template 204 by identifying links between a product (e.g., range 208) and a product location within the design template 204. A product location refers to any position within the design template 204 in which a product can be placed (e.g., a location in which a 3D product model can be generated). For example, the design template 204 might depict a room layout that calls for the placement of a single range. In that case, when a product of the type “range” is added to the product list, the home design tool 100 identifies the range 208 as a range, and attempts to locate a product location linked to range products. Home design tool 100 can identify a product as a certain type using a variety of techniques. For example, the home design tool can recognize keywords associated with the description of a product, or can be configured to recognize product images. In some examples, the home design tool 100 identifies a product location that is linked to range products. As a result, the home design tool 100 generates the 3D product model 210 in that product location.

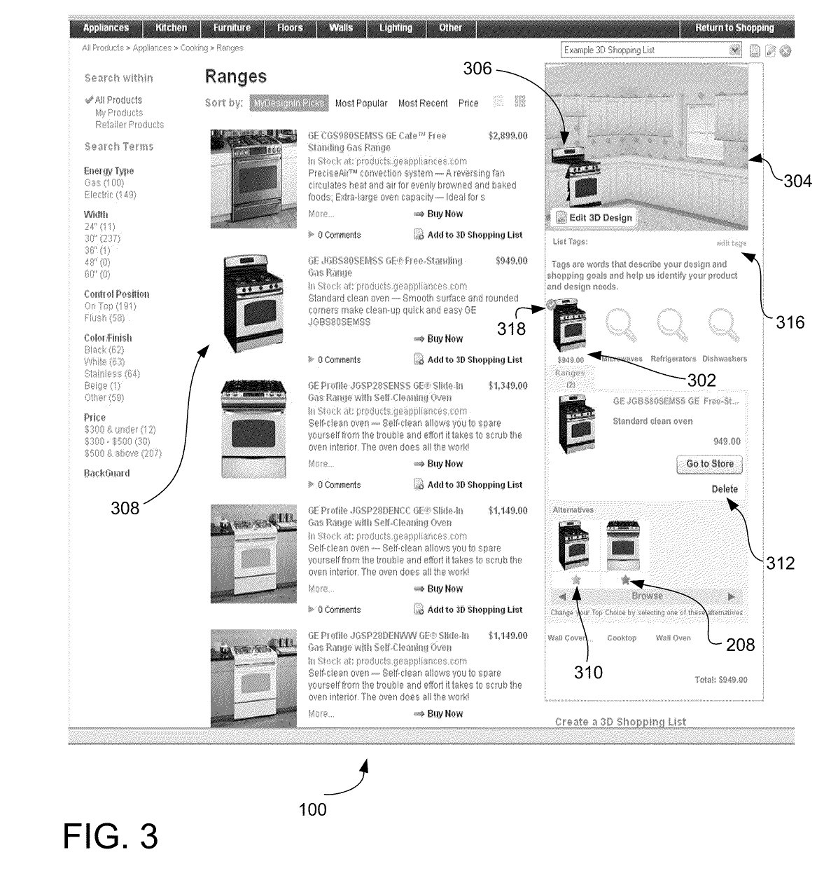

Referring to FIG. 3, the home design tool 100 again shows a design template 304 and a product list 202 (FIG. 2). In this example, a user has added range 308 to the product list, and a 3D product model 306 representing the range 308 has been generated in the design template 304. The product list displays a product icon 302 corresponding to the range 308 and the product model 306. The product icon 302 includes a visual “check mark” 318 that indicates that the range 308 is displayed in the design template 304 (as 3D product model 306).

While the example in FIG. 3 shows the new range 308 replacing the previous range 208 (FIG. 2) in the design template 304, it is not necessary for this replacement to occur automatically upon the selection of a different product from the product source. For example, as new products are added as product list items, the design tool 100 evaluates existing relationships between the products in the design template 304 and the product list. For example, a user can drag and drop a range into a design template, and the design tool 100 prompts the user to choose between adding the range as a “new product” or replacing an existing product in the design template.

If the user chooses to replace the existing product, the design tool 100 uses the location of the current product and replaces the corresponding search icon in the shopping list with the selected range. If the user chooses to add the range as a “new product,” the home design tool 100 allows the user to specify a location for the range in the design template 304. In addition, the range appears as a new product in the product list. Since the existing design item does not have an associated shopping list item, the search icon remains in the shopping list.

The design template 304 contains a product location for ranges that is linked to a corresponding search icon. If there are no other ranges in either the product list or the design template, the home design tool 100 adds the range to both the product list and the design template (as a 3D product model). As in the example of FIG. 3, the product icon 302 would also include a checkmark 318 indicating that the product in the product list is properly linked to a product location within the design template 304. In some examples, a highlighted star under a product indicates that the product is a user's “top choice” for that product type. An un-highlighted star indicated the product is an alternative and is not currently displayed in the design template.

A product (such as range 308) can be added to the product list as an “alternative product.” When a product is added to the product list as an alternative product, a 3D product model is not automatically generated in the design template 304. Instead, the product is added to the product list as an alternative to a product that is included in the design template. If no product from the product list is currently represented in the design template, then the alternative product will be added to the product list, and the corresponding product location within the design template will either remain empty, or can be represented by a generic product model (e.g., a grayscale “placeholder” product model). Placeholder product models can fill product locations within either a 2D or 3D design template (described in further detail below).

When the product list contains alternative products, a user can view the alternative products by expanding or activating the product icon 302. For instance, activating product icon 302 causes details about products within that product category (ranges) to be displayed. As shown in FIG. 3, the ranges product category includes the “top choice” range 310 that is currently represented within the design template 304 by 3D product model 306. The alternative range 208 is shown in the same frame, and a user can select the alternative range 208 as being the new “top choice” by, for example, activating a radio button beneath an icon representing the alternative range. If a user chooses to make the alternative range the top choice range, that range will then take the place of the range currently displayed within design template 304. The previous top choice change 310 would then become an alternative range to the newly selected top choice range.

The home design tool 100 understands that if the same product type, such as a range, is added more than once that the user may intend to only purchase one of these products types. Thus, the home design tool may prompt the user to make one of the products (ranges in this case) an alternative pick, which is then grouped with other selected products of that type within the product list. These grouped products within the product list can be applied to design templates. For example, if the user adds two or more products of a specific type to the product list, the home design tool may prompt the user to specify which entity they wish to group the new entity with or if they wish to add it as a new item. If only one product of a certain product type is added to the product list, the home design tool may add the product to the design template according to an existing relationship established between the product list and the design template.

Top choice or alternative products can be deleted from the product list by, for example, activating a delete button 312. In some examples, removing a top choice product from the product list causes the corresponding 3D product model to be deleted from the design template 304. A placeholder product model may replace the deleted top choice product within the design template 304, or an alternative product may automatically become the new top choice product, and may automatically be represented within the design template 304 in place of the deleted product.

Some products can only be matched to products from certain manufactures, types, or designs (e.g., a cutting board that only fits on a particular brand of sink). The home design tool can handle products with particular dependencies by linking a product with the product on which it depends. As a result, if a user selects a sink that is not compatible with a particular cutting board for inclusion within the design template, the home design tool can automatically swap the existing cutting board for a cutting board that is compatible with the new sink. The home design tool can notify the user of this change, and/or prompt the user to accept the change.

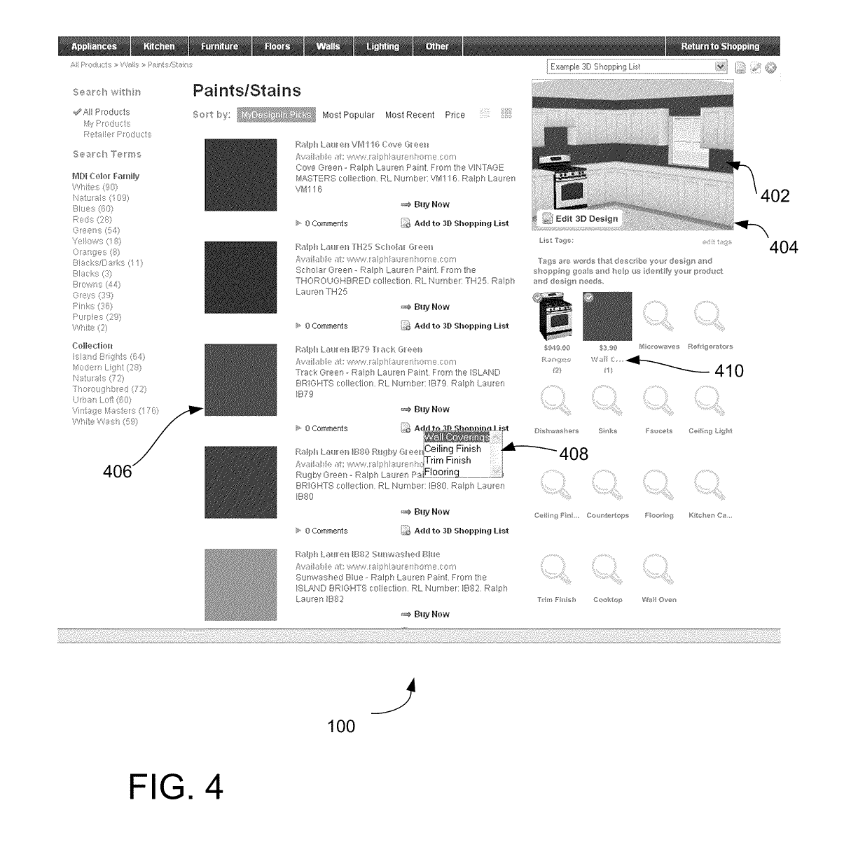

Referring to FIG. 4, the home design tool 100 can also provide an options menu 408 that logically relates to the use or position of a product (e.g., paint 406). The home design tool 100 can present the options menu 408 within the product source (as shown in FIG. 4) or within the product list (e.g., near product icon 410). For example, when a user selects paint 406 from the product source, the user is presented with options menu 408. When the selected product in the product source is the paint 406, the options menu 408 includes surfaces within the design template that the paint could be applied to. In this example, the “wall coverings” option from option menu 408 is selected, and the paint 406 is applied to surface 402 (the wall) in design template 404. The paint is applied to the surface 402 because the home design tool can map objects within the design template 404 to particular products. In this example, the home design tool 100 has determined that the surface 402 can be mapped to products of the type “paint.” Surface 402 might also be mapped to other products (e.g., the for a backsplash). The home design tool 100 can display similar option menus for other products such as tile, wood flooring, and molding. Other surfaces could include a ceiling, floor, countertop, or tabletop.

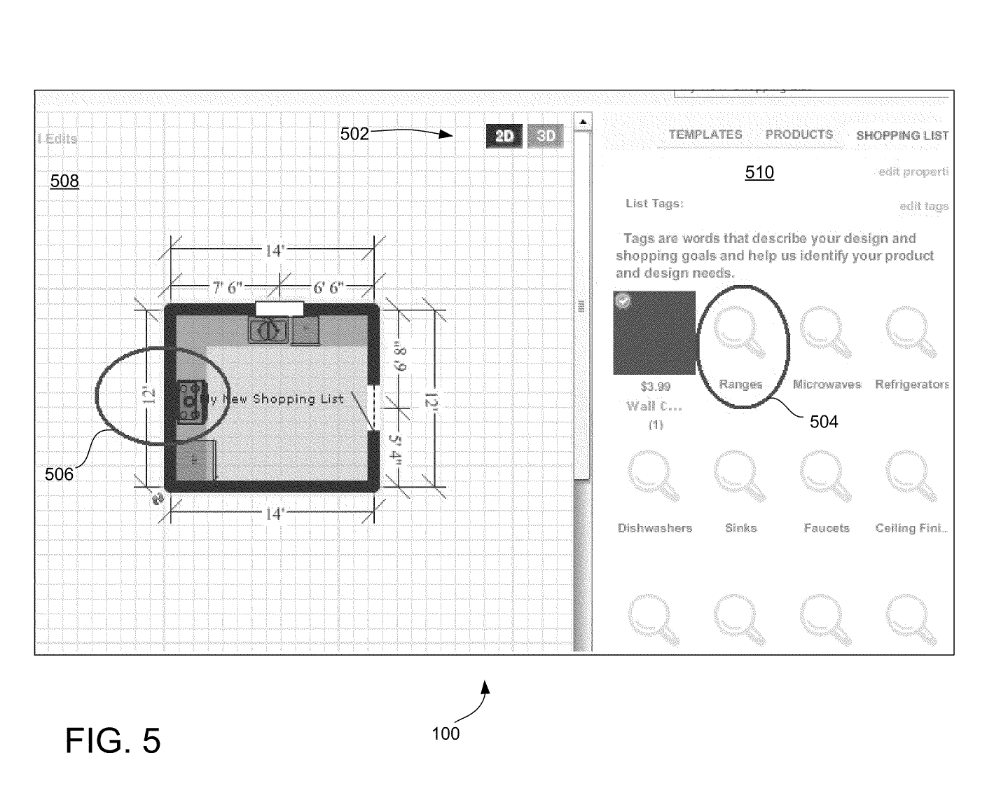

FIG. 5 shows the design template 508 in a 2D design mode. In 2D design mode, a 2D design template can replace the 3D design template on the web page, or can be displayed on the same web page simultaneously with the 3D design template. A user can toggle between the 3D mode (shown in FIG. 1, for example) and the 2D design mode shown in FIG. 5 by activating a button such as mode toggle button 502. In some examples, when the home design tool 100 is in the 2D design mode, a user may define and alter the structure and look and feel of a design. In the exemplary interface shown in FIG. 5, the home design tool is operating in the 2D design mode. In this mode, a user can alter room dimensions by dragging walls and the like or by typing in dimensional values. The system may automatically resize the 2D drawing or structural design layout according to the dimensions. The user may draw from additional sets of structural elements (not shown) such as windows, door or door openings, fireplaces, sets of stairs, and closets or pantries, for example. The sets of structural elements may be presented as results or suggestions to the user based on any of a variety of criteria, such as design rules, the designs of other users, adaptive learning based on neural network analysis of the design decisions of other users and the like. As more structural elements are added, the results or suggestions may be dynamically refined to reflect the modified structural design layout. A user may add other rooms and floor levels to the design as desired.

FIG. 5 also shows an example of the placeholder product models described above. That is, a placeholder product model 506 is displayed within the design template 508 even though there is no corresponding product in the product list 510. Because there is no corresponding product (a range in this example) the object type “ranges” is represented by a search icon 504. Placeholder product models can also be generated in the 3D mode, but may also exist in one mode and not the other. For example, if a user clicks mode toggle button 502 to enter the 3D design mode, the home design tool 100 might not generate the placeholder product model 506, according to user preferences or design rules. Furthermore, if a user places a cursor over the placeholder product model 506, the user can be presented with options to search for, purchase, or browse products of the type represented by the placeholder product model.

Users can also use placeholder product models to give the user multiple placement options within the design template 506. For example, relocating a placeholder product model to a new location within the design template 508 can change the product location mapping of the design template. For instance, if placeholder product model 506 (representing a range) is moved to a different wall within the design template 508 (e.g., by dragging and dropping the placeholder product model 506), the product location associated with the product type “ranges” is relocated to the new wall. As a result, when a user adds a range product to the product list, the 3D graphical representation of that range would appear at the new location (e.g., on the new wall) within the design template 508.

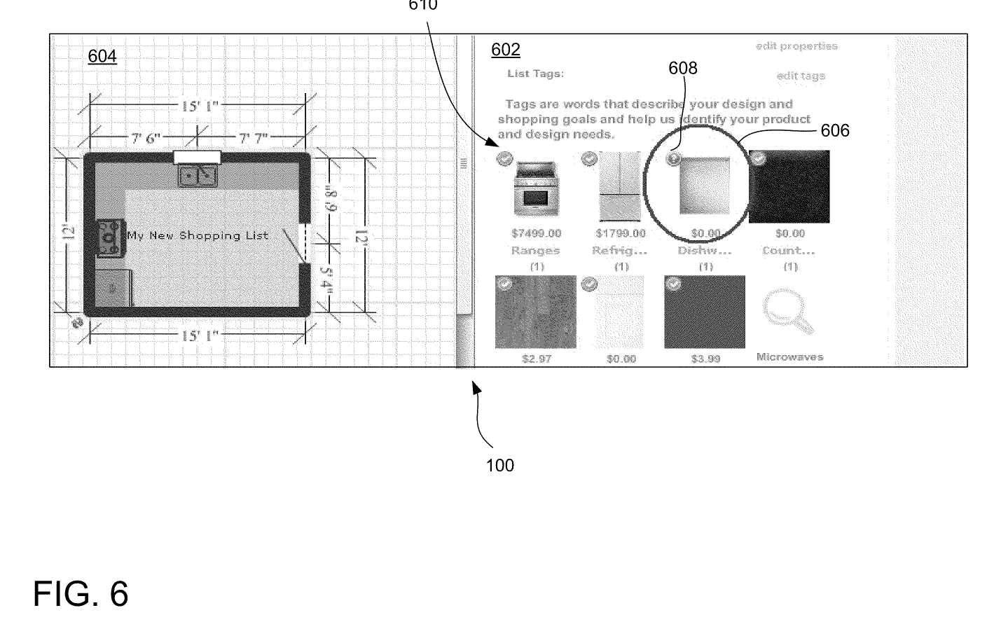

Referring to FIG. 6, the home design tool 100 displays a product icon (dishwasher) 606 within the product list 602. The product icon 606 representing a dishwasher is associated with a question mark 608 that is located near the product icon 606. As described above, as new products are added to the product list 602, the home design tool 100 evaluates relationships between the products in the design template 604 and the product list 602. If an existing relationship between a product within the product list 602 and a product location with the design template 604 is determined, those products icons that match are given a checkmark 610 as shown for the range in the shopping list 602. If a product is included in the shopping list but is not included in the design template (e.g., if no product location is determined for a certain product), then a “?” icon 610 is displayed over the product icon in the product list 602. This technique is a form of error handling in the process of determining relationships.

The product within the product list 602 can be given context (e.g., a proper location within the design template 604) in a number of ways. For example, a user can manually drag the product 608 one or more times into the design template 604 to establish one or more possible locations for the product. Once at least one possible product location has been established within the design template 604, the “?” icon can become a checkmark icon, as the relationship between the product within the product list 602 and a product location within the design template 604 has been established. Furthermore, if the home design tool cannot determine a product type for a particular product, the home design tool can prompt the user to categorize the product so that the home design tool knows how to handle it. For example, if a user adds an area rug to a product list but the type of product is unknown, then the system will prompt the user to categorize it (e.g., as an accessory or flooring).

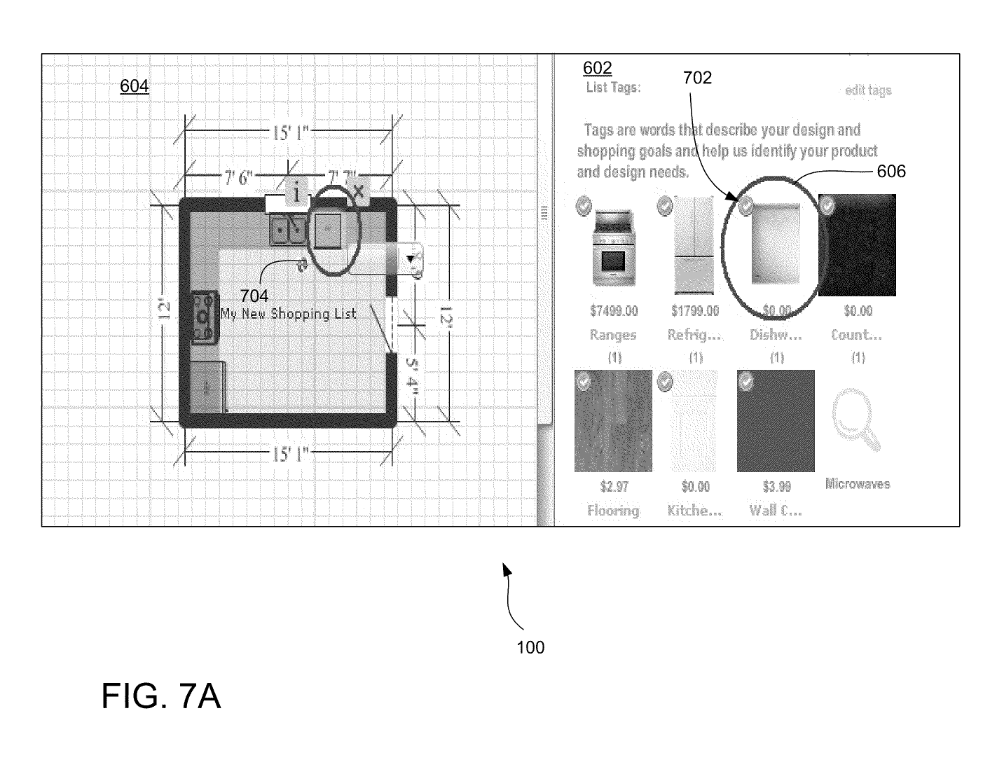

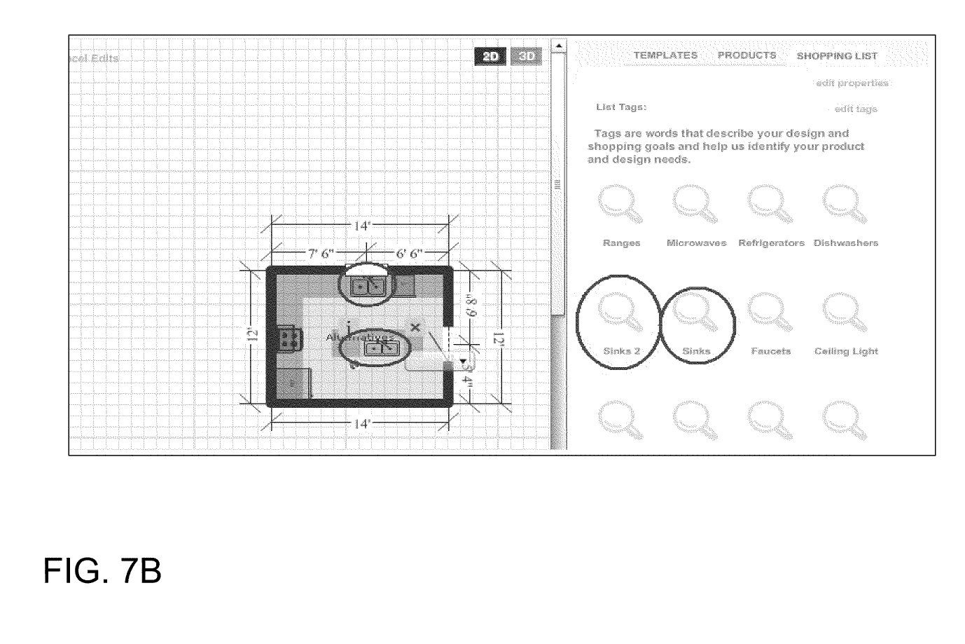

FIG. 7A shows an exemplary result of the above “manual mapping” of a product to a product location. Product 606 has been given a product location 704 within the design template 604 (e.g., by the dragging and dropping described above). As a result, the ? icon 610 associated with product 606 has been replaced by checkmark icon 702, and a graphical representation of the product 606 now appears within the design template 604 at product location 704. In some examples, the same product could be dragged and dropped multiple times into the design template 604 from the product list 602. This results in multiple instances of the product appearing in the design template 604. Until all instances of a product are deleted from the design template 604, the checkmark icon 702 remains on the product icon within the product list 602. Once the final instance of the product is deleted (e.g., once the final product location is removed from the design template 604), the “?” icon reappears for that product. Multiple instances of the same product can be represented by either a single product icon within the product list 602, or by respective product icons for each instance of the product within the design template 604.

A similar error handling process can also be used if a user wishes to replace the existing design template with a completely new layout. For example, if a user wishes to start over with a new kitchen layout (e.g., by replacing the design template with a different design template), the home design tool can automatically attempt to establish links between products in the product list and product locations within the new design template. As before, if no association is located for a particular product (e.g., if the new design template does not have a product location for that product), then the “?” icon will appear next to the product icon representing that product.

The search icons within the product list provide a number of additional features. For example, “core” search icons might always exist within the product list even if the corresponding objects are deleted from the design template. Core search icons can be defined as the products most likely to be found within a particular type of room. For example, a kitchen commonly includes wall coverings, a range, flooring, a sink, a faucet and refrigerator. Thus, even if a user deletes a refrigerator product location from the design template, a search icon for a product of that type can remain in the product list.

In some examples, a product is added as a new product to the product list, and then all products of that type are subsequently deleted from the product list. In this case, the search icon corresponding to that product can remain in the shopping list if it is the only search icon for the product type. If there is more than one search icon for the same product type, duplicate search icons can be removed from the product list so only one search icon remains. Additional search icons can appear as a result of one or more products being added to the product list. For example, if a user adds a sink to the product list, the design tool may add a search icon for drying rack accessories, prompting the user to search for drying racks. If the user clicks on the search icon, the home design tool 100 may limit search results to drying racks that are compatible with the active sink.

One or both of the product list and design template may include more than one instance of the same product type. In some examples, such as the example of FIG. 7B, a kitchen design template and its associated product list may include more than one sink. In that case, if the user adds a sink to the product list or the design template, the user can be prompted to make a choice between possible product locations within the design template. Product locations within the design template may be highlighted or color coded to help the user understand the choice being presented. An intelligence engine may automate the process completely or help the user chose by presenting the user with a default choice based on the relationships between product types and the product locations within the design template. For example, if the user is adding a second sink, and one sink within the design template is next to an under-counter refrigerator and another kitchen sink is next to the dishwasher, the home design tool may assume that the new entertainment sink should be placed next to the under counter refrigerator. Thus, the home design tool can present the user with this placement as the default option, or the placement can be completely automated.

Products, room templates, and other design ideas can be generated by the home design tool for a using a variety of techniques. While some of the techniques previously described involve a user selecting products from a global product source, other techniques can be used to help personalize the selection of products and design templates for a user.

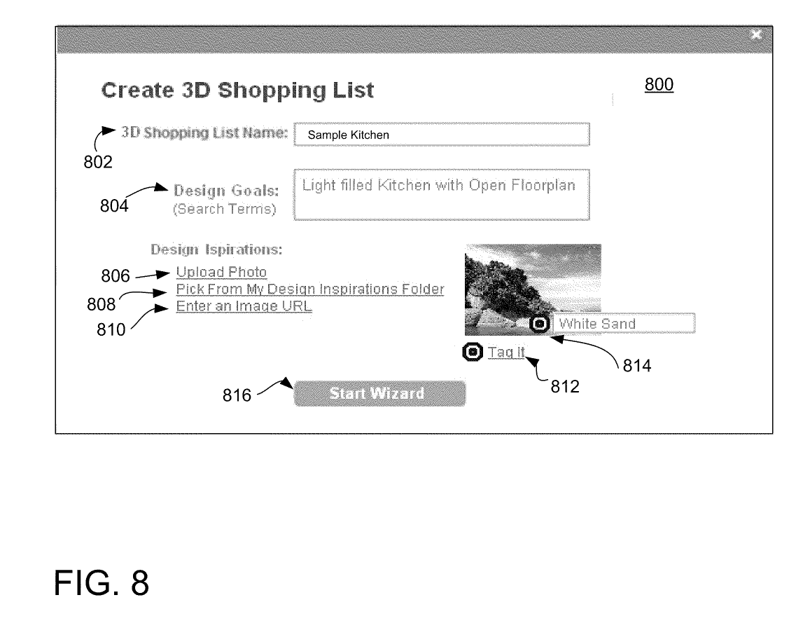

Referring to FIG. 8, the home design tool 100 may be used to generate a personalized product source, product list, and/or design template. FIG. 8 shows the first interface from a collection of interfaces that form a design wizard for this purpose. Interface 800 of the home design tool 100 allows a user to begin generating a product list (“3D shopping list”). A user can provide a name for the product list in field 802. The product list name can be used to recall a product list by a personalized name that may, for example, describe a project related to the product list. In the example of FIG. 8, the product list name is “Sample Kitchen,” which may imply that the product list is related to a kitchen.

A user can also establish design goals by providing field 804 with keywords related to a desired design theme. In some examples, a user can enter search terms to define their design goals such as terms that relate to the structural layout of the room (e.g., “light filled kitchen with open floor plan”) or things that relate to the style of the design (e.g., “traditional kitchen with Kohler® sink”). The home design tool can use the entered keywords to prioritize the order in which the design templates, products, or search results are displayed. For example, the keywords “light filled kitchen” may cause the home design tool to present a number of design templates, while prioritizing kitchens with a comparatively large number of windows or skylights. Those same keywords may also affect the products that are presented to a user for selection.

The interface 800 allows a user to design a room based at least in part on “Design Inspirations.” The design inspirations functionality allows the home design tool 100 to use data extracted from the inspiration (e.g., a photograph, picture, or video) to identify products and design templates that may be of interest to the user. In some examples, a user uploads a photograph 806 or enters an Image URL 810 to the design wizard.

Once the user has uploaded the photograph, the user can “tag” the photograph with attributes that further define their style and design goals by activating the “tag it” button 812. For example, the user can upload a photo of a beach (pictured), click on the beach with a cursor, and tag the portion of the photo as “White Sand.” As a result, both the tag words and the colors, textures and patterns of the tagged area of the photograph can be used to further refine suggestions for product selections and searches, partial product lists (e.g., a bedroom set) or complete product lists from advertisers, user generated content, and system generated shopping lists. These results may contain similar textures, colors or patterns or ones that are “complementary” to a design.

When the user tags the image, the home design tool may prompt the user to define an area of the image they wish to tag and what they like about it (e.g., the colors, textures or patterns). Design inspirations can be shared with a community of users over a network, such as the Internet, to allow for neural networking (e.g., the home design tool may indicate that users who liked white sand beaches also liked a particular type of range, and can suggest that range to a user). Other users may use the same image and tag various parts of the image with similar or different attributes. The tags assigned by a current user can be given the highest priority by the home design tool. Users can also access and draw from the product lists and design templates generated by other users. This features can be used to set initial search terms and offer a default design layout and related design template search results.

In some examples, a photograph of a room may be uploaded by a user. In this case, the home design tool can use edge detection technology to identify attributes, individual products, and layouts of the room to identify suggested design templates and product lists.

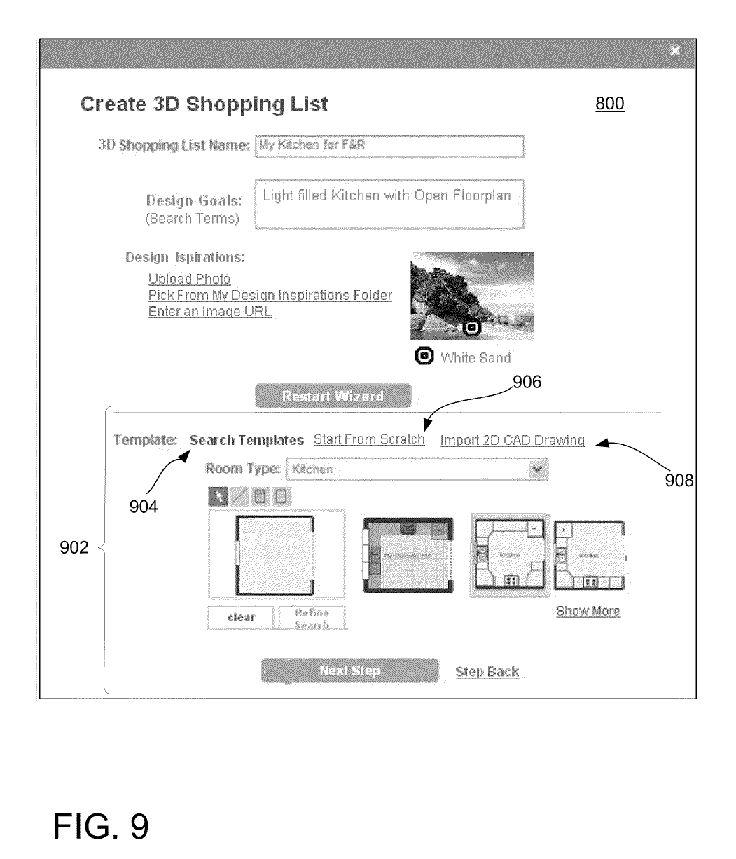

FIG. 9 shows a different portion of the interface 802 that appears, for example, after a user has advanced to the next stage of the design wizard. The template selection portion 902 of the wizard presents the user with a choice of design templates that match their previously stated design goals (e.g., the entered keywords or design inspirations described above). If the user included a room type as a keyword (e.g., the word “kitchen” in “light-filled kitchen”), the room type is automatically set. The user may also manually set the room type. If a selection is made that is different that the search terms, the system will indicate to the user a suggested alternative room name to select for the identified phrase in the search box.

The search templates option 904 allows the user to further refine design template search results. In some examples, the user may choose to “start from scratch” and use a template design tool immediately, or the user can wait until after completing the design wizard to design the room. The user may also chose to import a CAD design created using other web-based and desktop CAD applications. The home design tool can use the imported CAD designs to generate a design template and/or a product list.

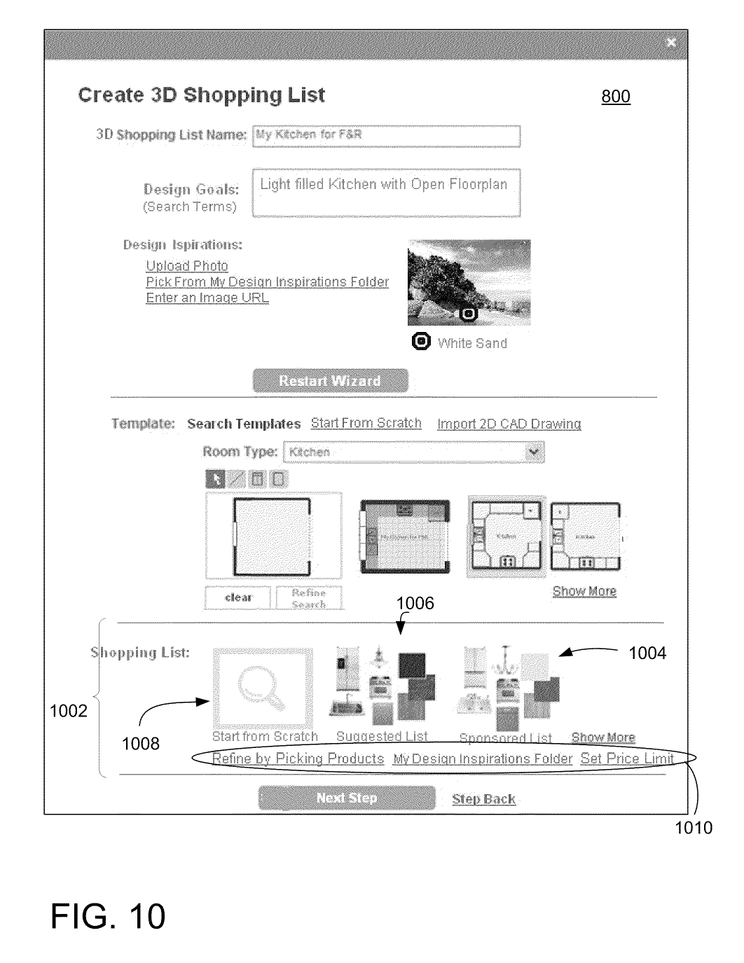

FIG. 10 shows a different portion of the interface 802 that appears, for example, after a user has advanced to the next stage of the design wizard. The product list selection portion 1002 of interface 802 presents a user with a choice of product lists that are associated with their previously stated design goals (e.g., the entered keywords or design inspirations described above). These product lists may include a suggested list 1006 of products for entire room designs, or partial shopping lists (e.g., sponsored lists 1004) such as a bedroom set sold by an advertiser. The user can also choose to start from scratch 1008, where they will be prompted to search for products in, and add products from, the shopping and design interface shown, for example, in FIGS. 1 and 2. The products lists presented to the user in the product list selection portion 1002 can also be filtered and refined with one or more filter options 1010.

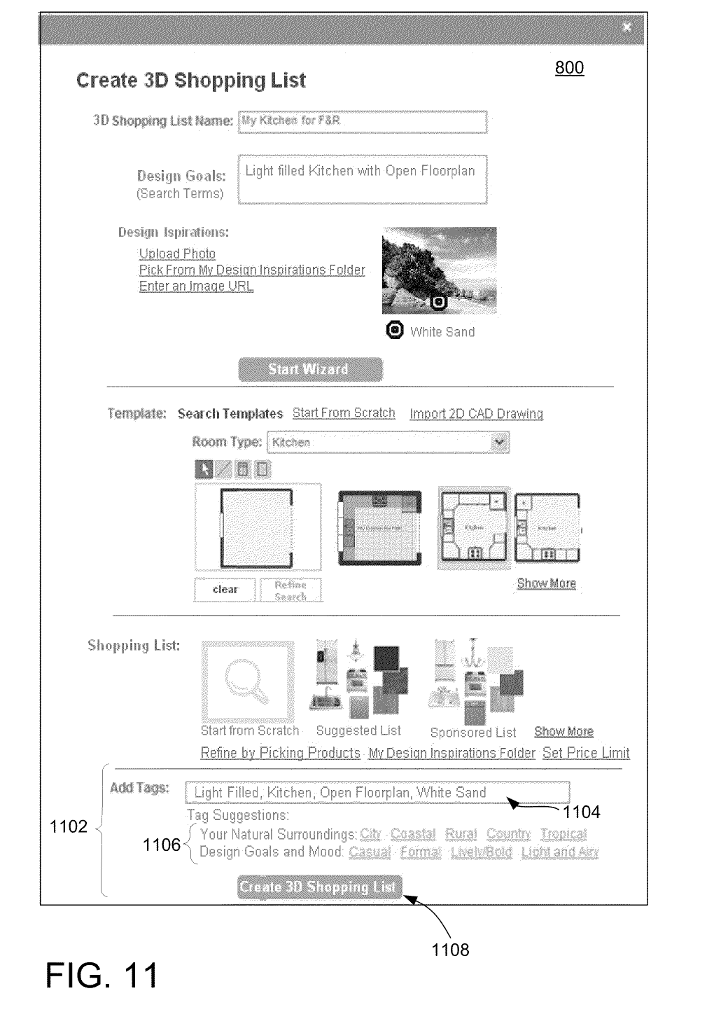

FIG. 11 shows a different portion of the interface 802 that appears, for example, after a user has advanced to the next stage of the design wizard. The tagging portion 1102 of interface 802 presents a user with the choice to assign tags to the product list that will further assist with product selection, presentations of complete or partial shopping list, design templates, and design template alterations. Tag field 1104 contains default tags are based on previously entered information (e.g., the entered keywords or design inspirations described above). The user may also manually enter any tags they wish to add into the tag field 1104. These tags are used for design search results in the room ideas section of the site. For example, a different user searching for designs related to certain keywords would locate a design with one or more of those tagged keywords. The user can also be presented with a choice of tags 1106 generated by the home design tool (e.g., the “mood” of the design). Once a user activates the “create 3D shopping list button” 1108, the home design tool generates one or more of a product list, a design template, and a product source.

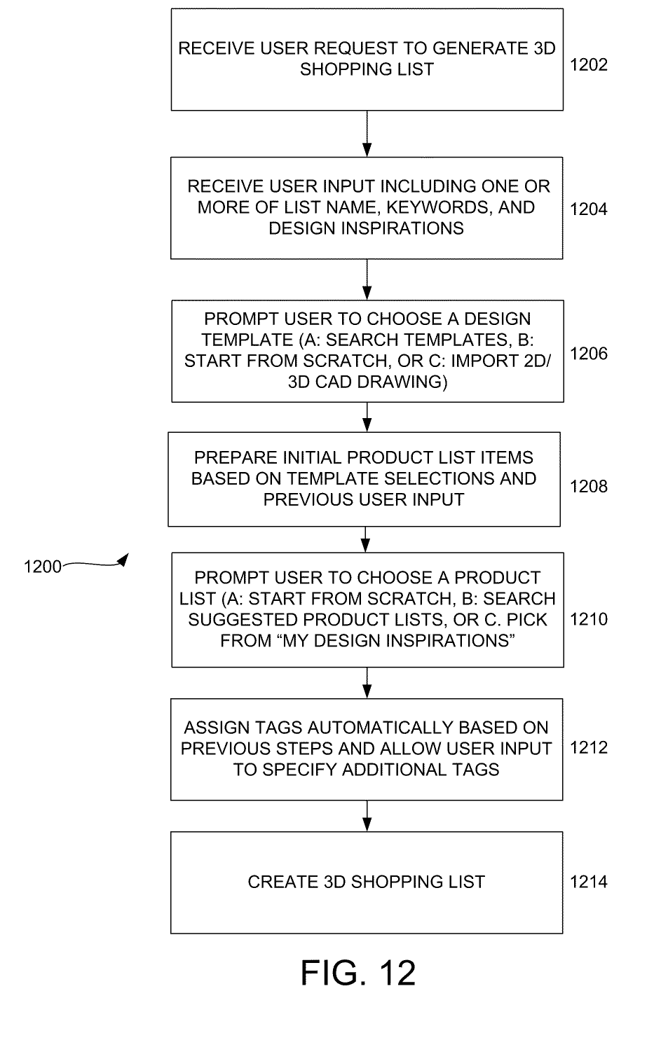

FIG. 12 is a flow chart representing an exemplary process 1200 for creating a 3D shopping list. The home design tool receives 1202 a user request to generate a 3D shopping list. The home design tool receives 1204 a user input including one or more of a 3D shopping list name, keywords, and design inspirations. The home design tool prompts 1206 the user to choose a design template using one of the previously described techniques (e.g., search templates, start from scratch, or import 2D/3D CAD drawing). The home design tool prepares 1208 initial product list items based on template selections and previous user input. The home design tool prompts 1210 the user to choose a product list using one or more of the previously described techniques (e.g., start from scratch, search suggested product lists, or pick from “My Design Inspirations”). The home design tool assigns 1212 tags automatically based on previous input and allows user input to specify additional tags. The home design tool creates 1214 the 3D shopping list.

Users can also design layouts and choose products based on one or more “anchor” products. An anchor product refers to a product that a user wishes to base further design upon. For example, if a user chooses an area rug for a design, the user may wish to add a coffee table to the design based on colors, textures, or a style of the area rug. The home design tool can suggest products and layouts that are associated with the anchor product in some way (e.g., by using a characteristic of the anchor product to choose further products/layouts, or by suggesting products/layouts that previous users have paired with that anchor product).

In some examples, the home design tool can capture “snapshots” of one or both of the product list and the design template (including the products within the design template). That is, a snapshot of the product list captures and saves the status of the products within the product list. For example, if a user takes a snapshot of the product list, the snapshot would include the “top choice” products, as well as the alternative product selections that have already been stored within the product list. Once the snapshot has been saved, a user can recall the saved state of the product list by, for example, activating a button within the home design tool.

A snapshot of the design template (sometimes referred to as a “layout snapshot”) captures and saves the current position of objects (e.g., products and design features) in a design and allows a user to return to the specified layout at any time. Recalling either a product or layout snapshot can optionally cause the home design tool to automatically update the other of the product or layout snapshot. For example, if a user recalls a layout snapshot, not only can the state of the layout be changed, but the product list can be updated to include the products represented in the design template (as well as any alternative products).

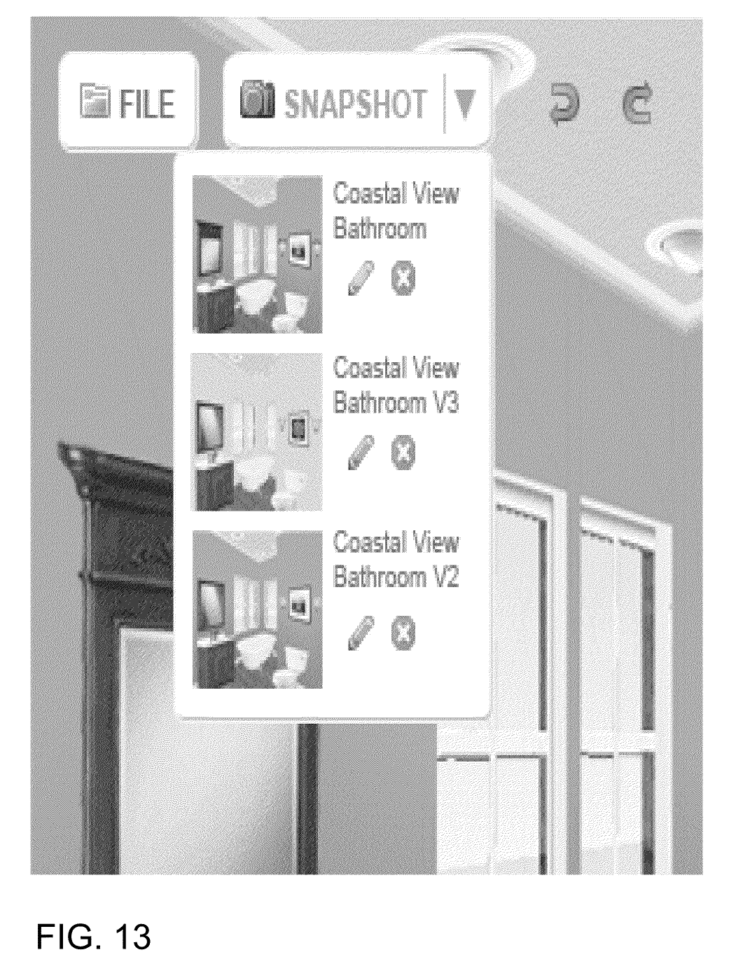

In some examples (such as the example of FIG. 13), a user can take a snapshot of the design template and the product list simultaneously. Then the user can continue editing the 3D Shopping List and return to the snapshot at anytime. Once a snapshot is created, the user can also make a named snapshot the active snapshot and edit it so changes in both the shopping list and design template are reflected in the active snapshot. This feature takes advantage of the product alternatives and error handling features described above. The snapshot feature captures the state of the product alternatives and the location and design related properties of objects within the design template, allowing a user to return to this state of the design and shopping list at any time.

The introduction of a new product in a product list may have no impact on a snapshot that was previously created. When a user switches back to a previous snapshot, the error handling technology (described previously) simply assigns a “?” icon to the item until a link to a product location with the design template is established, or until the user recalls a different snapshot. In some examples, if a new product is added in one snapshot and a user recalls a previous snapshot, the new product remains as an alternative product available within the snapshot. In some examples, the home design tool may also assign a new icon such as a “broken camera.” A user can click on the broken camera to assign the newly added product to a different snapshot. The home design tool can highlight the objects that can be used in the original snapshot and allow the user to pick which objects they wish to include. The initial location of these objects is displayed relative to the location of the walls. If the walls are different between templates, the home design tool attempts to identify common shared walls as well as coordinates of the drawing space. Hovering over the broken camera icon may provide a list of snapshots in which the item is active.

When a user deletes a product within a product list that is associated with a snapshot, the system should notify the user that deletion of the product will affect the snapshot. Furthermore, the home design tool can cause the next alternative product in the list to take the place of the deleted product. If an alternative product is not available, then the home design tool can use the previously described rules for search icons. Users can make global changes that affect all stored snapshots, or can make changes to a single snapshot that do not affect other stored snapshots.

A user may add multiple products at one time to the 3D shopping list. In some examples, a user may wish to add a multi-product design contributed by another user or a product set from a manufacturer (e.g., a bedroom set) to a 3D shopping list. When the user adds a “collection” of products to a 3D shopping list, the new items in the collection can automatically be designated as the user's new top picks, and any existing products within the design can become alternative products. The user can also designate products individually. The home design tool may also group collections within a shopping list allowing a user to switch between entire collections when switching between alternatives.

The home design tool can also be used to add cabinets to a design using “single click” techniques that are similar to the techniques discussed above. For example, if user chooses to add a cabinet to the 3D shopping list (e.g., by activating the “add to 3D Shopping List” button) for a specific a product line from a manufacturer, the home design tool can automatically apply the cabinet (or cabinet set) to the design template. Applying the cabinet set to the design template can include assigning the appropriate cabinet sizes and styles to the right locations in the design template based on the cabinet layout templates within the design template, configuration data from the manufacturer, personalization data, and other user input.

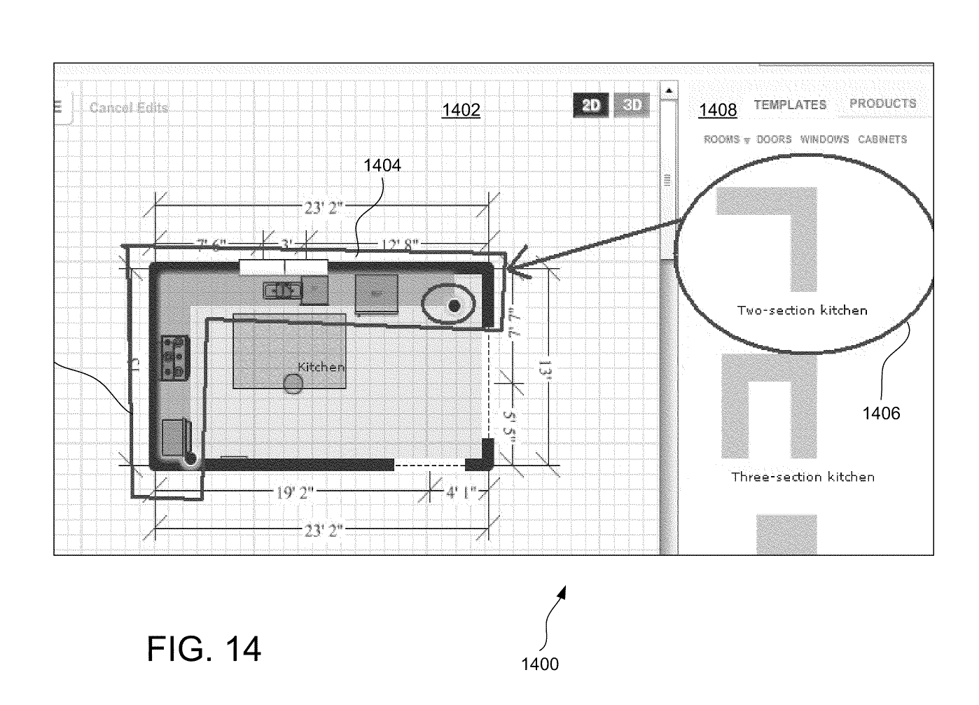

Referring to FIG. 14, cabinet layout templates 1406 can be dragged and dropped from a cabinet template source 1408 into a location 1404 design template 1402. The settings and dimensions of cabinet layout templates 1406 can be adjusted. Upper and lower cabinet templates may be added and adjusted independently to define the location in which the cabinets will applied. By using the home design tool 100, a user is not required to configure cabinets independently. Instead, the home design tool 100 allows the user to do conceptual design, while allowing the home design tool to automate the detailed configuration for cabinets within the design.

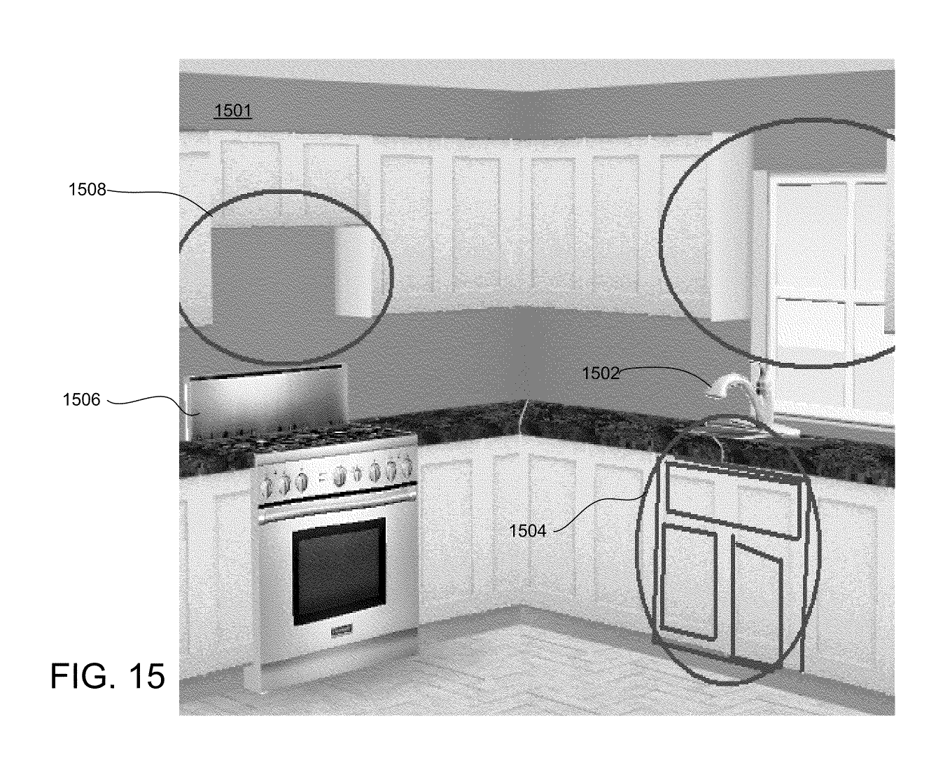

Referring to FIG. 15, the home design tool can take into account the impact of adding new products (e.g., cabinets) into a design template 1501 that contains cabinets. For example, if a kitchen sink 1502 is added to the design template, the home design tool can use a design rules engine to determine that, for example, a 36″ sink style cabinet 1504 should be placed under certain sink types (such a self-rimming and undermount sinks) The design rules engine can also determine a size, position, color, type, or style of cabinet to place within the design template. In some examples, a range 1506 that does not have a built in ventilation system may cause the home design tool to display a placement area 1508 for a hood or over-range microwave. The home design tool may also suggest alternative layouts, sizes, and styles of cabinets that can be rendered within the design template.

The design template can also define “zones” such as a cooking zone, a preparation zone, a cleaning zone, an eating zone, or a work zone, and can suggest cabinet types for each zone type. The home design tool can identify zones within the design template using a variety of techniques. For example, the home design tool can identify objects or products within the design template (e.g., a sink would commonly be located in the preparation zone, or a cook top would commonly be located in the cooking zone). The home design tool may also evaluate the overall layout and identify suggested zone locations and sizes (e.g., the home design tool could suggest locating the preparation zone close to the refrigerator, or could suggest an optimal or minimum size for a particular zone. Zones can be graphically represented within the design template, and can be resized by the user, or can be resized automatically by the home design tool according to design rules. For example if a user adds a refrigerator drawer for storing things like vegetables for salads, it may be assumed that the prep area for this user is more important than other areas and increased automatically. In this case the cabinets may be wider in this space and offer more drawers.

As a user adds items to a design template, the home design tool may suggest alternative locations for products such as appliances in order to maintain zones. Users may also add zones manually by dragging and dropping graphical representations of zones from a source, and selecting predefined zone types. The home design tool also allows a user to create a new zone type, and may prompt the user to indicate activities or product types to associate with the created zone.

A user may define a room type (e.g., “kitchen” or “living room”) in either the design goals section described above, by selecting a room type from a drop down menu, or by answering a series of questions generated by the home design tool. The home design tool may ask questions to identify a lifestyle of the user to provide a shopping and design experience that matches that lifestyle. For example, if the user selects a family room for a room type, the home design tool may ask questions that relate to the type of activities that the user plans to do in that room (e.g., read, watch television, or entertain). Based on responses to the questions, the home design tool can identify zones within the room and prioritize them accordingly. For example, if the user indicates that entertaining large groups is the most important feature for a family room, but also indicates that watching TV is an important activity, the home design tool can make “entertaining zones” proportionally larger than in other family rooms, and can make the television watching zone proportionally smaller. The home design tool can then find, for example, design templates that have an open floor plan for entertaining, French or sliding glass doors to an outdoor area, and/or a wet bar within the room. However, because television watching is also an important activity for the room, the design template would also include appropriate seating arrangements for both entertaining and watching television.

The entertaining zone or sub-zones in the room that offer open space for people to stand during a cocktail will be given a higher priority while the zone for media cabinets may be given a lower priority. As a user searches for new products, search results are impacted by the active template and associated personalization data (e.g., a user's answers to the previously described questions relating to zone prioritization). For example, if a user creates a 3D shopping list for a kitchen and specifies that eating salads is a popular activity in that user's household, then while the user is searching for refrigerators, the home design tool may suggest a refrigerator drawer for the kitchen. The home design tool may also include a search icon for refrigerator drawers, and may have template items in the design template for prompting the user to add a refrigerator drawer to their 3D shopping list. The home design tool may also provide the user with refrigerator search results for refrigerators that include plenty of space for vegetable storage.

A zone prioritization wizard may help a user identify which zones they find most important based on lifestyle questions. The zone prioritization wizard may use existing design data to some initial assumptions about the design (e.g., if the refrigerator contains a large vegetable drawer, the home design tool might estimate that the user likes to make salads). The home design tool can also present the user with additional questions relating to the user's lifestyle, the answers to which can be used in prioritizing the zones. The wizard can also ask the user to confirm the prioritization decisions, and allows the user to manually set the minimum size of a zone.

Zone prioritization data is used to adjust sizes of zones accordingly. For example, a typical cleaning zone may be 24″×36″ but may be increased in size relative to the size of a kitchen based on the user's lifestyle selections. For example, if the user indicates that he enjoys baking, that activity and corresponding room may require a larger cleaning zone. Zones may be allowed to overlap due to limited space constraints. For example, using the prioritization wizard, if a user may add a refrigerator drawer for vegetables, the home design tool might assume that the user enjoys making salads. As a result, the home design tool might prioritize that user's zones in the following order: preparation; clean; eat; cook. A user that indicates “entertaining” as a top priority could have their zone priorities as: eat; serve; preparation; clean; cook.

Zones may be broken into multiple zones as required based on layout and zone prioritization data. Relationships within and between zones may also need to be established. For example, someone that likes to bake might want dry food storage close to the preparation zone.

As a user adds items to a design, the home design tool may suggest alternative locations for products like appliances in order to maintain zones. Users may also add zones manually by dragging and dropping them from the templates tab and selecting predefined zone types. The home design tool may also allow a user to create a new zone type and ask the user which activities or product types will be important for a given zone.

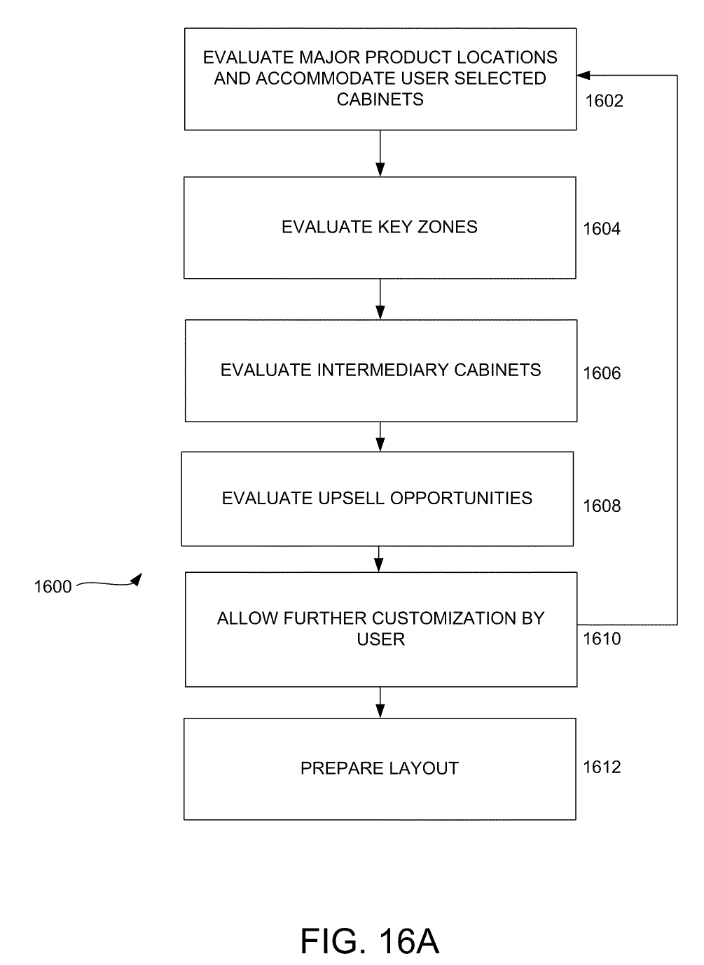

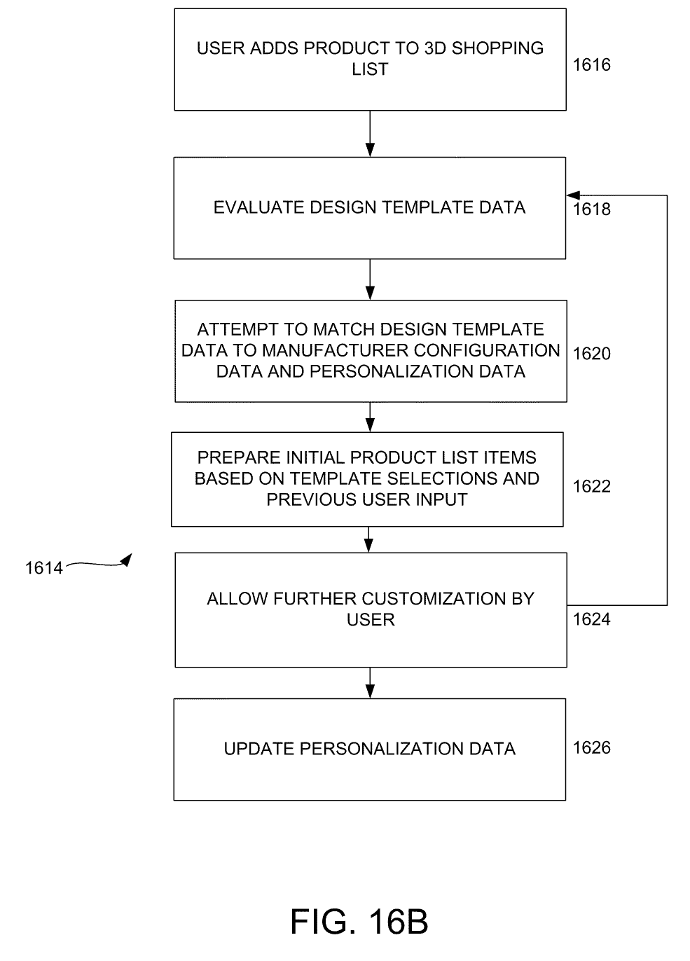

When evaluating template data for possible cabinet layouts, the home design tool can prioritize cabinet information based on objects such as appliances and plumbing fixtures, as well as zones to make a decision. An exemplary process 1600 for designing a layout for kitchen cabinets is shown in FIG. 16A. The home design tool evaluates 1602 major product locations and accommodates user selected cabinets. For example, after evaluating the design, the home design tool may decide that since the layout contains a sink, a 36″ cabinet should be placed under the sink. The home design tool evaluates 1604 key zones. Zones may be prioritized based on data collected in a personalization engine. For example for a user who likes to bake, the home design tool can assign cabinets with large drawers or other storage for mixing bowls. The home design tool evaluates 1606 intermediary cabinets. For example, the home design tool considers cabinet data (e.g., data established at 1602 and 1604, as well as zone personalization data and appliance and plumbing fixture locations). For example a filler cabinet might be changed to set of large drawers if the preparation area consists primarily of 36″ wide cabinets with one drawer and door. The home design tool evaluates 1608 up-sell opportunities. For example, the home design tool may add glass doors as the top matching setting for a serving zone for someone who likes to entertain. As new products are added, the home design tool may revisit 1602-1608. The home design tool allows 1610 further customization by the user, and prepares 1612 the kitchen cabinet layout.

The data is stored and used to prepare the home design to accept cabinet lines from manufacturers. After one or more actions, the home design tool identifies the ideal cabinet type as well as alternatives and more standard cabinet types and attributes to accommodate all manufacturer product lines. As new items are introduced to the templates and shopping list the process may run again taking into account the user specified data and personalization data.

The home design tool gathers template data including customization requests, zone changes, the introduction of unique items (e.g., refrigerator drawers) and other stored preferences and actions by the user. When the user adds a product to the 3D shopping list, the home design tool matches the gathered data to the configuration options available for the selected product in order to identify the correct cabinet for the user.

Some or all of this data is prioritized and used to calculate the suggested cabinet sizes and types that are then matched to the actual configuration options carried by a manufacturer for given product lines. An exemplary process flow 1614 for matching design templates to product line configuration data and personalization data is shown in FIG. 16B. A user adds 1616 a product to the 3D shopping list. The design template data is evaluated 1618. The home design tools attempts 1620 to match the design template data to manufacturer configuration data and personalization data. The home design tool prepares 1622 initial product list items based on template selections and previous user input. The home design tool allows 1624 further customization by a user (sometimes resulting in a return to design template evaluation 1618). The personalization data is updated 1626.

If objects are placed in locations that result in odd sized standard cabinet sizes, the home design tool may suggest alternative locations by displaying a faint version of the object in 2D or 3D. The user can allow the system to make all adjustments as they add items like appliances. In some examples, the home design tool may prohibit a user from placing an object in a location that results in odd cabinet sizes.

The home design tool collects data from the design template, including customization requests, zone changes, the introduction of products, and other stored preferences and actions by the user. All of the data collected by the home design tool can be prioritized and used to calculate a suggest type, size, and style of cabinets to be placed in the design template. These suggested attributes can then be matched to the actual configuration options offered by a manufacturer, with the matching configuration options being selected automatically, or being presented to the user for selection.

Manufacturers can construct a database that includes some or all of the configuration options available for particular product types. This data includes cabinet sizes, types, options, and other data and is appropriately matched to the data from the cabinet layout templates and also personalization data that has been gathered. User can switch between brands and product lines, and the home design tool identifies which cabinets the selected manufacturer carries and matches it to the template data. The matching process is similar to the process shown in FIG. 16A, and allows for the home design tool to identify custom cabinet requirements (e.g., if a user selects a cabinet design that does not map to a manufacturer's product).

After a product is added to the product list and the design template, a user can select individual cabinets and choose alternative cabinets sizes and types from the manufacturer. This customization may result in the home design tool (automatically or when directed by the user) recalculating the matching process between the template data and the manufacturer configuration options. Items that have previously been customized may be ignored in the recalculation process to avoid losing the user's previously-selected cabinets types.

The customization process may also provide for error handling. To see this information in a shopping list the user can expand the kitchen cabinet shopping list item and see “?” icons on individual cabinets that the user may want to adjust. The home design tool can also display alternative locations or product types when a user selects an individual cabinet.

Cabinet products can be grouped together in the product list into a single, expandable product type. In some examples, the single, expandable product type is graphically represented in the product list or the product source as a single cabinet door. When expanded, the single cabinet door can display further configuration options associated with the selected cabinet. In this manner a user can easily switch between brands and product lines using the alternative product handling described above. When expanding the “cabinet” product type, the home design tool displays some or all of the products associated with the kitchen cabinets (e.g., trim, hardware, drawers and the like).

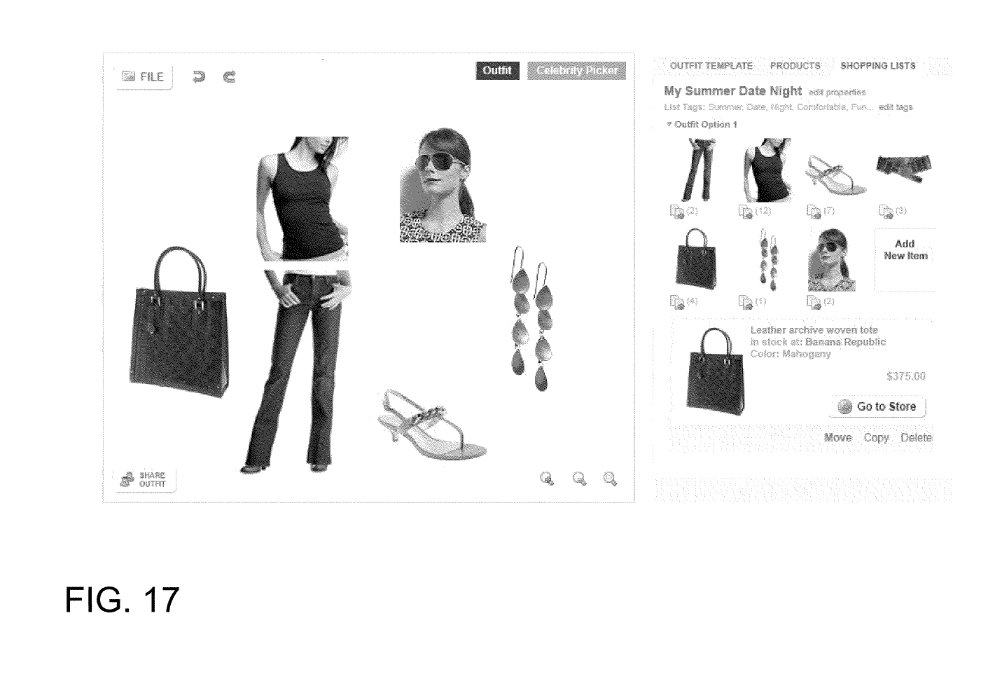

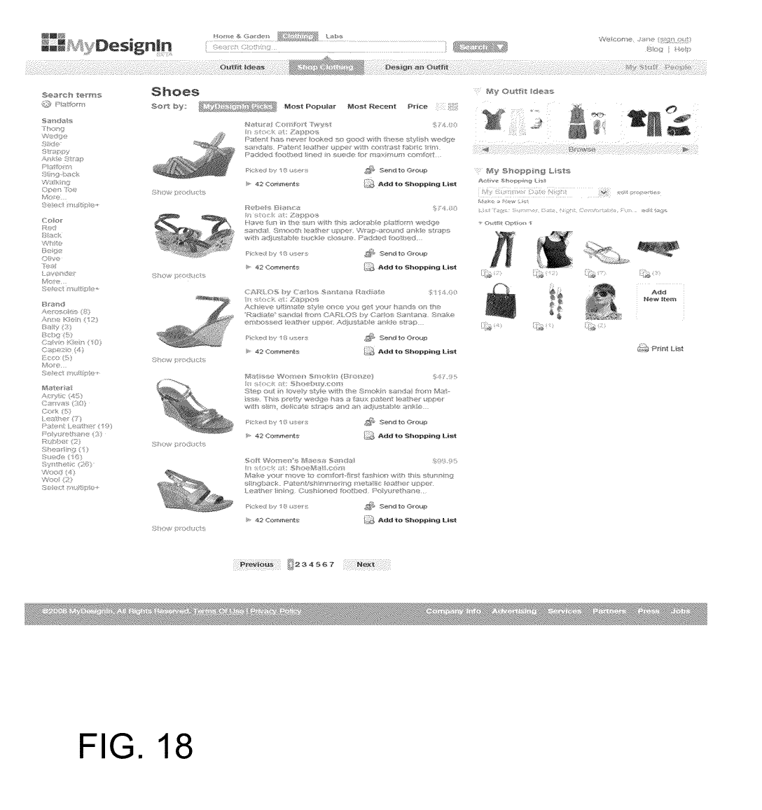

FIGS. 17 and 18 show an example of using the home design tool for clothing-related shopping and design.

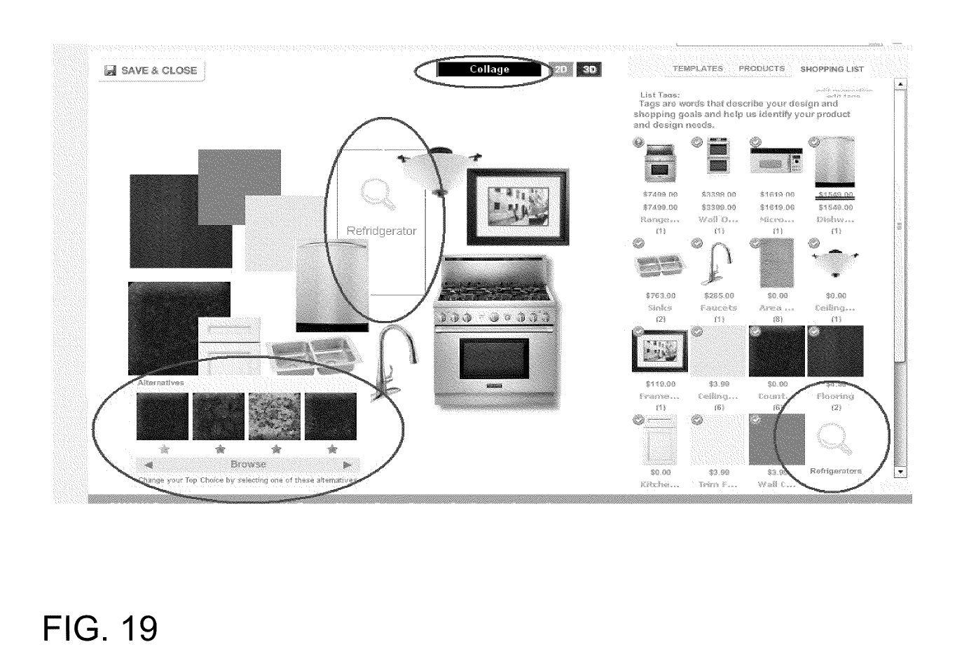

Referring to FIG. 19, design templates also include a collage view mode. When using one-click design, a product can be is added to 2D, 3D and collage views simultaneously. Templates have predefined locations for items in the collage view, grouping products that typically need to be coordinated such as fixtures for coordinating finishes or paint, flooring, cabinet and countertop samples. When a user switches to collage view, any items that do not have a predefined location will be grouped with items based on predefined category groupings. When a user switches to collage view, a “?” icon may also appear in the shopping list if the item is included in 2D and 3D mode but not collage view. Alternatives are handled in the same manner described above, allowing alternatives to updates in all three view (2D, 3D and collage view) simultaneously. Users may select the item within Collage or 2D or 3D view and choose an alternative which in turn updates all views and the shopping list.

In some examples, a professional designer working at kitchen bath dealers, window and door dealers, small boutiques and other dealers or independent designers can choose user actions and time spans that will trigger the generation of an advertisement. For example, if a user spends 30 seconds moving windows and doors around or other structural items and an advertiser bid on this action within a 30 mile radius of their store, the advertisement may be triggered. Another trigger could be as simple as adding kitchen cabinets to a design when in a 50 mile radius of dealer of those cabinets. If a user is spending a lot of time laying out a room, the users can be served collaboration advertisements from window and door companies. If a user is using cabinets within a certain distance radius of an advertiser, users can be served collaboration ads for the kitchen cabinet dealer.

In some examples, the home design tool may try to up-sell a user to additional products based on their activity within a product list or design template. For example, if a user selects an island to put in a kitchen and specifies that it should have an overhang for chairs, the home design tool may introduce chair template items in the design template based on the length of the area designated for the overhang. The home design tool may also add a search icon to the product list section to prompt the user to search for chairs. The search icon may be a single item in the product list but multiple instances in the design template. The number of instances of the item in the design template can be based on calculations of the design rules engine (e.g., the width of the overhang area can determine the number of chairs to include in the design template).

The home design tool can act as a collaboration platform between consumers and professionals. While professionals may use the home design tool (or a professional version of the home design tool) to collaborate with clients or prospective clients, the home design tool offers interoperability with other CAD systems allowing consumers or professionals to upload a CAD file into the home design tool, make changes in the home design tool and then bring those changes back into a CAD system.

By using the CAD interoperability system, the home design tool can take a detailed CAD file and extract, consolidate, and simplify the CAD file into a 3D shopping list with a suggested list of products to search and shop for, and can also generate a design template integrated with the product list. By converting CAD data into a 3D shopping list, the home design tool facilitates the ability for a user to use one click design capabilities with the imported CAD data, eliminating the need to learn complex CAD systems.

During the import process, relationships between product list items and the design template are established for the consumer where one product list item may have multiple instances in the design template. Some items may not be included in the CAD file at all. For example, a wall may consist of a simple 2D object in the CAD system and have no property for paint. The home design tool identifies the object as a wall and associates the inside of the walls with a new shopping list item called wall coverings. When the file is exported back into the CAD system, the properties portion or materials list data for the wall will have a link to the product the user selected in the home design tool for price comparison, or link to a 3RD party site for purchasing. The link to the third party site acts as a form of advertising where a different party can receive a commission on sales or a “cost-per-click revenue.” Alternative product selections may also be added to the notes area of the item properties or materials list section of the CAD application.

During the import process, the home design tool recognizes an object such as a sink, and identifies attributes such as the style and type of sink. The home design tool then attempts to match that item with an item in the database. The object is placed in the correct location based on the coordinates extracted from the CAD system. If the product does not match a design template item, then the original file is translated using typical data translation processes. In some cases, the CAD system may not have the actual physical representation of the object required by a 3D shopping list. For example, an architect may add a simple callout with an arrow or leader line pointing to a wall for wainscoting to be applied to a wall. The callout may include product type information and height information. This data can be extracted to find a wainscoting object in home design tool database, assign correct property information (e.g., height), and apply it to the designated walls (designated in the text of the callout, or because the callout is shown in multiple locations in a room). If a callout is shown in multiple locations in the room, and the same callout is used (or multiple leaders go from the same callout), the home design tool can consolidate the item into a single shopping list item.

Extraction of Shopping Lists items from CAD Drawings may also use shape recognition technology, symbol names, tags and other attributes as well as configuration data (e.g., size and type) to identify items in the database for inclusion in both the design template and the product list. The home design tool may allow a user to confirm or deny matched results.

The home design tool also extracts the attribute data from the object and assigns it as a tag to the template item and search icon. In the case of an exact match from the data in the CAD file and a product in a product database, the home design tool automatically adds the correct product from the database to the shopping list. If a match can not be found, the home design tool notifies the user and may use an icon representing a failed match over the product in the product list. When the user clicks on the search icon, the home design tool finds products with similar attributes.

The original CAD file and the 3D shopping list may be stored independently. In this manner, the integrity of the original CAD file can remain intact. Any changes made in the template within the home design tool can be compared with, and translated back into, the CAD system. The home design tool includes an export wizard that notifies the user of changes within the design template prior to exporting the file into the professional CAD system, and allows the user to accept or deny those changes. The home design tool can also notify another user of the “accept” or “deny” status (e.g., an architect may be notified that a user/customer has accepted a change). When new objects are introduced to the 3D shopping list and are then exported to a CAD system, these items are translated into the CAD system internally before the file exportation is complete. A script method may also be used as an add-on to the CAD system. This method uses a file recipe to natively build the “symbol” in the CAD system.

In a script-based approach, the home design tool supplies CAD files in a recipe format. The home design tool then runs a script within the native CAD system recreate the CAD file natively in that system.

Data extracted from the CAD file is used to enhance search results such as dimensions, colors, textures and other attributes. If the home design tool finds search results that match the attribute data above a threshold value (e.g., a 100% match), then the products can be automatically placed in the design template and are linked to shopping list items. Users may need to specify the type of product for certain products, and possibly chose a symbol for the product if no match can be made.

Advertisers can place advertisements based at least in part on the personalization data provided throughout the site (e.g., data from the personalization wizard, the design goals, and other data associated with a specific 3D shopping list). For example, a user may indicate information about their sex, age and other demographic information when they create a profile within the home design tool. When a user creates a 3D shopping list, the user may indicate that they enjoy entertaining large groups. An advertiser may discern that this user meets a certain demographic profile, and may choose to advertise certain products or sets of products against these attributes. Furthermore, the advertiser may provide design templates, individual products, or product lists that meet the expected needs of a user having a particular demographic profile.

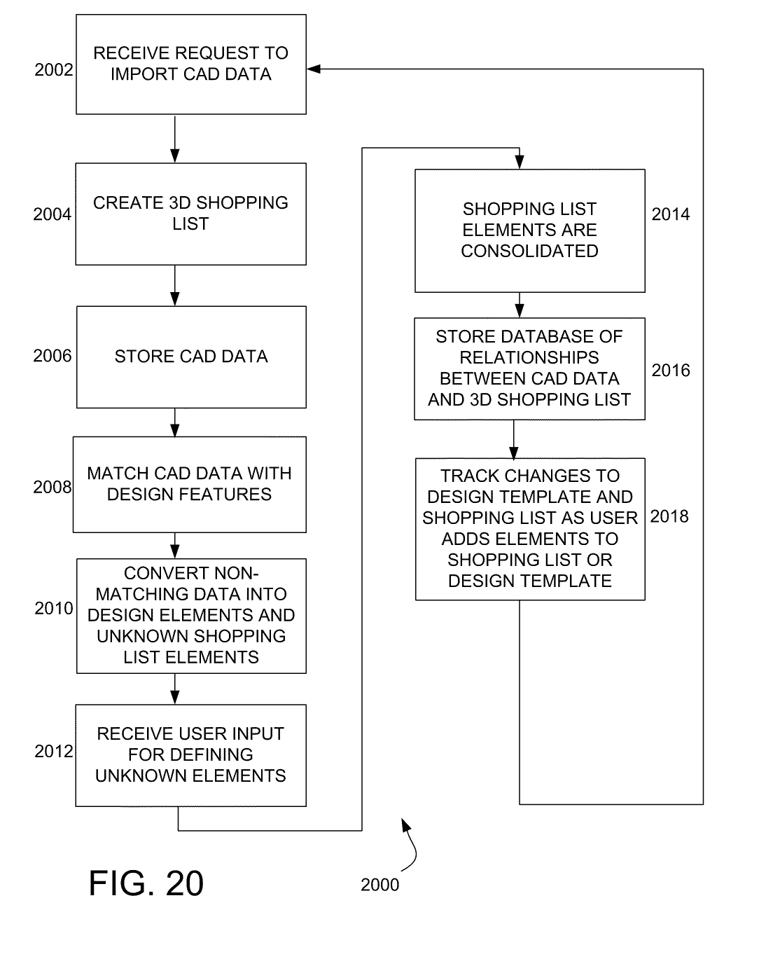

Referring to FIG. 20, a process 2000 is shown for importing data from a CAD file in connection with generating a 3D shopping list. A request is received 2002 to import CAD data. A 3D shopping list is created 2004. The CAD data is stored 2006 (e.g., in an independent file to preserve the integrity of the important file). The CAD data (including object attributes) extracted from the CAD file is compared and matched 2008 with design features (e.g., design template, design elements and shopping list elements). Non-matching data (e.g., CAD data that does not match any design elements) is converted 2010 into an “unknown” shopping list element (which can be represented, for example by a “?” icon). User input is received 2012 for defining unknown elements (e.g., using the techniques described above for assigning a product type or product location to an object). Shopping list elements are consolidated 2014 (e.g., multiple instances of an element—such as an AutoCAD block—can be consolidated into a single shopping list item). Relationships between the CAD data and the 3D shopping list are stored 2016. Changes to the design template and shopping list are tracked 2018 as a user adds elements to the shopping list or to the design template.

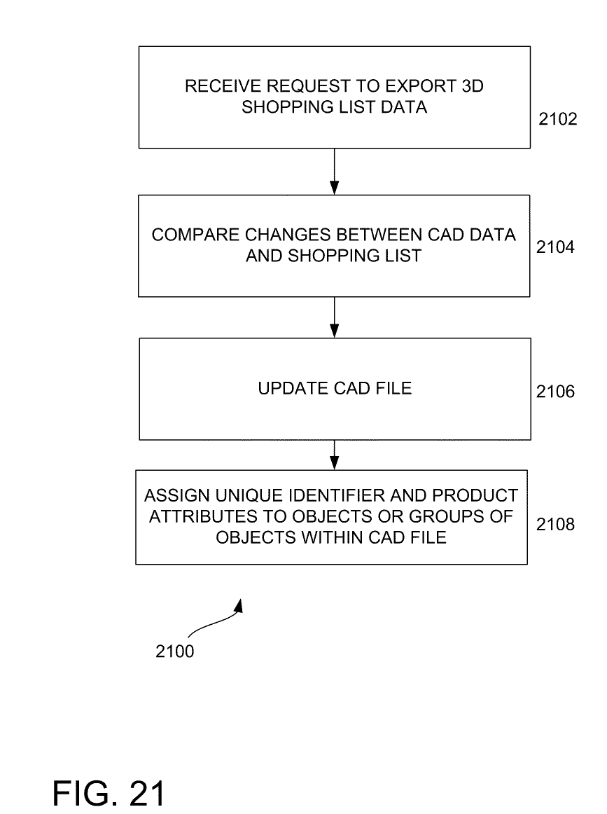

Referring to FIG. 21, a process 2100 is shown for exporting data into a CAD file or system. A request is received 2102 to export 3D shopping list data. Changes between CAD data and shopping list data are compared 2104. The CAD file is updated 2106 (e.g., move, resize or change properties of objects that existed in original CAD file). Unique identifiers and product attributes (e.g., product URL, name, price, and description) are assigned 2108 to objects or groups of objects within the CAD file.

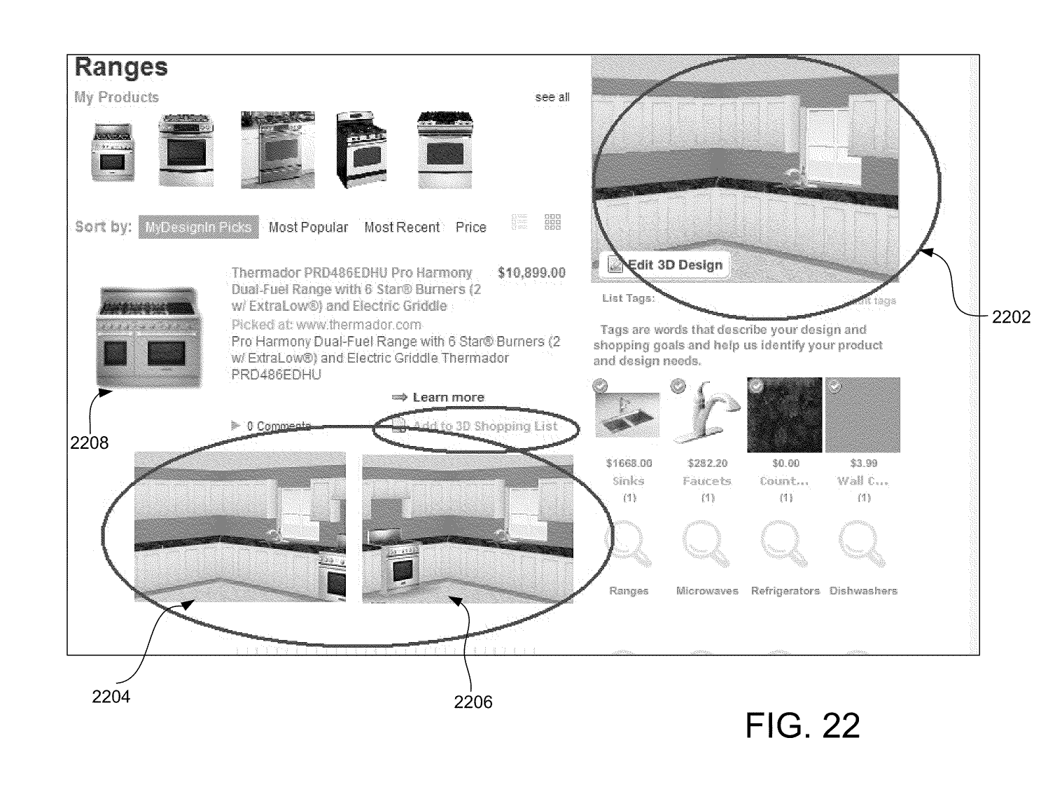

Referring to FIG. 22, if a user adds a product as a “new” product to the 3D shopping list and the design template does not contain product locations associated with the new product, the home design tool can allow a user to manually place the new item in a template (as described above), or can identify a suggested location based on neural networking technology, a design rules engine, personalization data, and zone data.

In some examples, a user can specify that the added product is a “new” product, and the home design tool will assign a “?” icon to the product in the product list until a product location is identified for that product. A user can also be prompted to manually assign a location within the design template to the product.

In some examples (such as the example of FIG. 22), the design template does not contain a product location for the new product (e.g., the design template 2202 does not contain a product location for the product type “ranges”). The home design tool can then suggest locations for the new product based on neural networking technology, a design rules engine, personalization data, and zone data. As shown in FIG. 22, the home design tool has suggest two layouts 2204, 2206 that contain a product location for the selected new range 2208. As new items are introduced, the home design tool may need to relocate existing items in the design template 2202. The existing items that are moved can be highlighted in the template to ensure the user can see the new changes suggested by the home design tool.

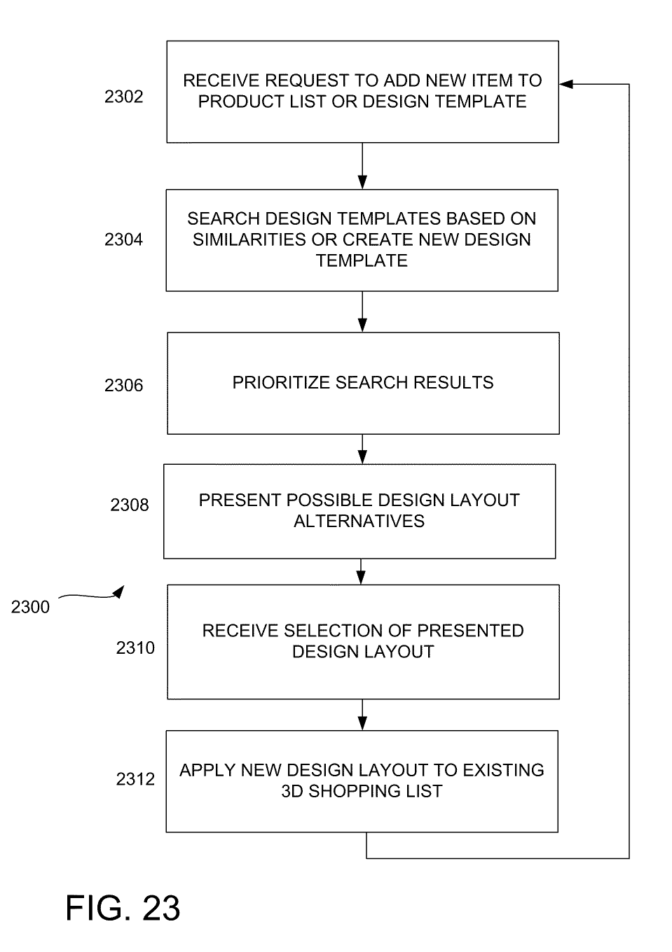

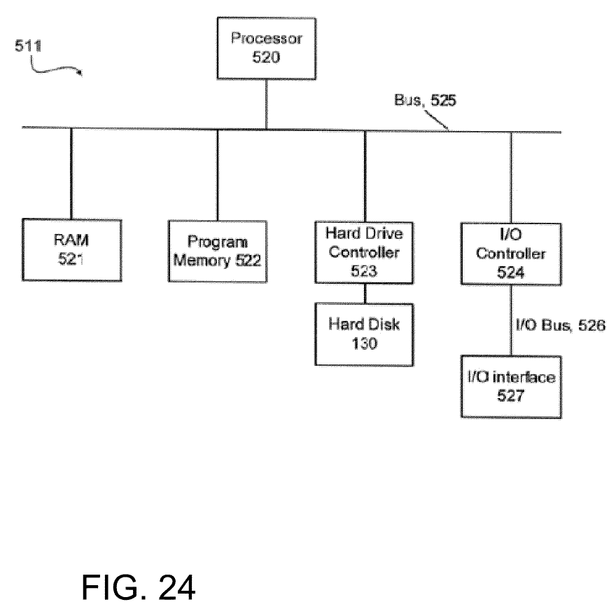

FIG. 23 shows a process 2300 for suggesting layouts upon the addition of a new product. A request is received 2302 to add a new element to the product list or the design template. Design templates are searched 2304 based on similarities, or new design templates are created. Search results are prioritized 2306 based on one or more factors (e.g., personalization data, zone information, popularity of a given design template, etc . . . ). Possible design layout alternatives are presented 2308. An indication of a selection of one of the presented design layouts is received 2310. The new (e.g., the “selected”) design layout is applied 2312 to the existing 3D shopping list.

The techniques described herein, including techniques depicted in flowcharts, may contain features that can be performed in an order other than the order shown or described to achieve a similar result.

The systems and methods described herein can be implemented in digital electronic circuitry, or in computer hardware, firmware, software, or in combinations thereof. The methods and systems described herein can be implemented in a computer program product tangibly embodied in a machine-readable storage device for execution by a programmable processor and method actions can be performed by a programmable processor executing a program of instructions to perform functions described herein by operating on input data and generating output.

The systems, software, and methods described herein can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files, such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD ROM disks. Any of the foregoing can be supplemented by, or incorporated in, ASICs (application-specific integrated circuits).

An example of one such type of computer is shown in FIG., which shows a block diagram of a programmable processing system (system) 511 suitable for implementing or performing the apparatus or methods described herein. The system 511 includes a processor 520, a random access memory (RAM) 521, a program memory 522 (for example, a writeable read-only memory (ROM) such as a flash ROM), a hard drive controller 523, and an input/output (I/O) controller 524 coupled by a processor (CPU) bus 525. The system 511 can be preprogrammed, in ROM, for example, or it can be programmed (and reprogrammed) by loading a program from another source (for example, from a floppy disk, a CD-ROM, or another computer).

The hard drive controller 523 is coupled to a hard disk 130 suitable for storing executable computer programs, including programs embodying the present methods, and data including storage. The I/O controller 524 is coupled by an I/O bus 526 to an I/O interface 527. The I/O interface 527 receives and transmits data in analog or digital form over communication links such as a serial link, local area network, wireless link, and parallel link.

While the system and methods described above have been directed to an implementation of the home design tool for design and layout of rooms for a house, the tool is not limited to home designs, as such, other implementations are possible. For example, the home design tool could be used to generate a layout of an office building or other commercial space. In addition, the home design tool could be used to generate layouts of garden or other landscaping features.

Elements of different implementations described herein may be combined to form other implementations not specifically set forth above. The home design tool described above is not limited to home design layouts. For example, similar design tools can be used to produce, for example, exterior/landscaping layouts, factory equipment layouts, industrial and commercial layouts, clothing ensembles/outfits, office space layouts, restaurant layouts, and the like. Other implementations not specifically described herein are also within the scope of the following claims.

What is claimed is:

1. A method performed using a processing device, the method comprising:
rendering, on a display associated with the processing device, a diagram of a plan for a layout, the diagram comprising one or more element locations;
receiving, via the processing device, an indication of a selection of a first element from a source of elements;
adding, via the processing device, the first element to a list of elements associated with the diagram;
identifying, via the processing device, an association between the first element and one or more of the element locations; and
updating the diagram to include a graphical representation of the first element within the diagram at one or more of the element locations.

2. The method of claim 1, wherein the first element is selected from the source of elements.

3. The method of claim 1, wherein the list of elements includes one or more alternative elements.

4. The method of claim 1, wherein one or more of the plan, the list of elements, and the source of elements is generated based on one or more attributes of an image.

5. The method of claim 4, wherein the one or more attributes comprise one or more of a texture of the image, a color of the image, a pattern of the image, or tags associated with the image.

6. The method of claim 1, wherein the diagram is imported from a computer aided drawing (CAD) file.

7. The method of claim 1, wherein one or more of the plan, the source of elements, and the list of elements is generated based on keywords.

8. The method of claim 1, further comprising adding a second element to the list of elements by receiving one or more commands to drag a graphical representation of the second element onto a graphical representation of the list of products, or by receiving one or more commands to activate a button associated with the second element.

9. The method of claim 8, wherein the second element is added to the list of elements with a designation of an alternative element, a new element, or an active element.

10. The method of claim 9, wherein if the second element is designated as an alternative element, the diagram is not updated with a graphical representation of the second element.

11. The method of claim 9, further comprising attempting to associate the second element with one or more of the element locations if the second element is designated as a new element.

12. The method of claim 11, wherein, if no association is determined:
prompting a user to manually associate the second element with one or more of the element locations.

13. The method of claim 9, wherein, if the second element is designated as an active element:
updating the diagram with a graphical representation of the second element.

14. The method of claim 9, wherein, if the second element is designated as an alternative element:
changing the designation of the second element from an alternative element to an active element causes the diagram to be updated with a graphical representation of the second element.

15. The method of claim 9, further comprising storing the list of elements and designations of the elements as a first snapshot.

16. The method of claim 15, further comprising storing a second list of elements and designations of the elements as a second snapshot;
wherein toggling between the first snapshot and the second snapshot displays the list of elements and designations of the elements stored within respective snapshots.

17. The method of claim 16, wherein toggling between the first snapshot and the second snapshot updates the diagram based on designations of the elements.

18. The method of claim 1, further comprising attempting to associate the first element with one or more of the element locations if the diagram is altered.

19. The method of claim 18, wherein, if no association is determined:
prompting a user to manually associate the first element with one or more of the element locations.

20. The method of claim 1, wherein element locations are graphically represented within the diagram by generic elements.

21. The method of claim 1, wherein the association is identified based on a design rules engine that identifies associations based on contextual relationships.

22. The method of claim 1, wherein the updating comprises rendering a graphical representation of one or more cabinets in the diagram according to a design rules engine to form a cabinet arrangement.

23. The method of claim 22, wherein the design rules engine determines one of more of the type, position, or size of the cabinets based at least in part on zones defined by the layout.

24. The method of claim 23, wherein the zones are prioritized according to user-provided attributes.

25. The method of claim 24, wherein the user-provided attributes are received as answers to a questionnaire.

26. The method of claim 23, wherein the design rules engine compares the cabinet arrangement to one or more pre-defined cabinet arrangements.

27. The method of claim 22, wherein the cabinet arrangement is manually modified by a user.
